(19) United States
(12) Patent Application Publication
(10) Pub. No.: US 2023/0300468 A1
(43) Pub. Date: Sep. 21, 2023

(54) METHOD AND DEVICE FOR DISPLAYING OMNIDIRECTIONAL HAZARD OF AIRCRAFT

(71) Applicant: THINKWARE CORPORATION, Seongnam-si (KR)

(72) Inventors: Yo Sep Park, Seongnam-si (KR); Suk Pil Ko, Seongnam-si (KR); Shin Hyoung Kim, Seongnam-si (KR)

(73) Assignee: THINKWARE CORPORATION, Seongnam-si (KR)

(21) Appl. No.: 18/107,699

(22) Filed: Feb. 9, 2023

(30) Foreign Application Priority Data
Feb. 9, 2022 (KR) 10-2022-0017027
Feb. 9, 2023 (KR) 10-2023-0017552

(51) Int. Cl. H04N 23/698; H04N 7/18; G06V 20/58

(52) U.S. Cl. CPC H04N 23/698; G06V 20/58; H04N 7/181

(57) ABSTRACT

Disclosed is a method of displaying an omnidirectional hazard of aerial vehicle. The method includes generating an omnidirectional image based on the aerial vehicle by using a plurality of flight images acquired from each of a plurality of cameras equipped in the aerial vehicle, determining whether a hazard exists within a predetermined range based on a location of the aerial vehicle, classifying whether the hazard is a mobile object or an immobile object when the hazard exists within the predetermined range based on the location of the aerial vehicle, and displaying a risk guidance object in the omnidirectional image based on the classified hazard.

### BACKGROUND

### 1. Field

The technical idea of the present disclosure relates to a method and device for displaying an omnidirectional hazard of a UAM aerial vehicle capable of generating an omnidirectional guidance image based on the UAM aerial vehicle using a plurality of cameras applied to the aerial vehicle and expressing the detected hazards in the omnidirectional guidance image.

### 2. Description of Related Art

Urban air mobility (UAM) may be a next-generation mobility solution that maximizes mobility efficiency in the urban area, and has emerged to solve the rapid increase in social costs or the like such as reduced movement efficiency and logistics transportation costs due to congested traffic jam in the urban area.

In modern times where long-distance travel time has increased and traffic jam has worsened, the UAM solving these problems is considered a future innovation business.

The operation of the initial UAM used a new airframe type certified for flight in the current operating regulations and environment. For the introduction of the UAM operations, innovations in related regulations and UAM dedicated flight corridors may be introduced. New operating regulations and infrastructure enable highly autonomous traffic management.

Due to the increase in ground traffic every year, the time required for travel becomes longer, resulting in considerable economic cost loss. As a concept of city-centered air transportation that has been continuously discussed for this purpose, the limitations of the existing helicopter-type transportation have not been resolved, and as a result, high costs of operation and customer service and negative public perceptions of noise and pollution have hampered significant market growth.

This has led to the search for alternative transportation means, and the evolution of modern technology has made it possible to support the development of the concept of the UAM. In this sense, the introduction of the concept of the UAM suggests a new approach to alternative air transportation means in the urban area.

The UAM aerial vehicle is generally transportation means that constructs a next-generation advanced transportation system that safely and conveniently transports people and cargo in the urban environment based on electric power, low-noise aircraft, and a vertical take-off and landing pad. The reason why the above-described low noise and vertical take-off and landing should be premised is to increase the movement efficiency when operated in the urban area.

Due to the activation and commercialization of such unmanned aerial vehicle, the demand for effective control and management of the unmanned aerial vehicle is increasing. To this end, it is necessary to visualize a flight route of the unmanned aerial vehicle in order to allow the unmanned aerial vehicle to fly or to effectively manage the route of the unmanned aerial vehicles in flight.

In general, the currently commercialized aerial vehicle provides a route guidance service to a pilot by a method of providing the flight route and operational information through a multi-function display installed in the aerial vehicle, but since this conventional method simply displays route information between a departure point and a destination numerically or in a radar form, the conventional method has a problem in that only experienced pilots may acquire the information and the pilots may not confirm in real time the presence or absence of hazards for the external environment in relation to the aircraft operation.

In addition, while the UAM aerial vehicle flying in the urban environment having a low flight altitude is frequently exposed to dangerous objects (electric wires, birds, buildings, etc.), the pilot may only confirm a front view, so it is difficult to detect dangerous objects located on or approaching a rear surface, a side surface, or the like of the unmanned aerial vehicle.

Therefore, for the commercialization and stable flight of the UAM aerial vehicle, it is necessary to visualize a flight route on a 3D map for an intuitive and effective visualization of the flight route, and it is necessary to visualize various factors, such as whether flight is permitted, route setting, detection of ground buildings, and detection of dangerous objects, along with the flight route.

Also, in the related art, there is no user-friendly navigation for the aerial vehicle. Recently, as technology for the UAM is being developed, it is expected that the user-friendly navigation will be required as the UAM is activated.

In addition, there was a problem that it is difficult to visually (intuitively) identify the designated route which is the conventional aerial vehicle display method. Therefore, it is expected that it will be difficult to travel a first route when the UAM is activated later or the route becomes complicated.

### SUMMARY

Accordingly, an object of the present disclosure is to solve the above problems.

The present disclosure is to provide a method of monitoring all directions based on aerial vehicle using a plurality of cameras.

The present disclosure is to provide a method of expressing hazards detected during flight in an omnidirectional guidance image.

The present disclosure is to provide a UAM aerial vehicle to which the above-described system is applied.

In an aspect of the present disclosure, a method of displaying an omnidirectional hazard of aerial vehicle includes: generating an omnidirectional image based on the aerial vehicle by using a plurality of flight images acquired from each of a plurality of cameras equipped in the aerial vehicle; determining whether a hazard exists within a predetermined range based on a location of the aerial vehicle; classifying whether the hazard is a mobile object or an immobile object when the hazard exists within the predetermined range based on the location of the aerial vehicle; and displaying a risk guidance object in the omnidirectional image based on the classified hazard.

The classifying of the hazard may include determining whether the hazard is an immobile object, and the immobile object may include at least one of a building, a region, and an altitude.

The displaying may include displaying a risk guidance object for the immobile object in the omnidirectional image.

The displaying may include determining a risk level for all directions of the aerial vehicle based on at least one of a time to collision (TTC) and a distance required for the aerial vehicle to collide with the immobile object to display the risk guidance object for the immobile object in the omnidirectional image.

The classifying of the hazard may include determining whether the hazard is a moving mobile object, and the mobile object may include at least one of another aerial vehicle and a bird flock.

The displaying may include displaying a risk guidance object for the mobile object in the omnidirectional image.

In the displaying, a moving direction of the mobile object may be measured, and it may be determined whether the moving direction of the mobile object is a direction interfering with a moving route of the aerial vehicle to display the risk guidance object for the mobile object in the omnidirectional image.

The displaying may include determining a risk level for all directions of the aerial vehicle based on a time to collision (TTC) and a distance required for the aerial vehicle to collide with the mobile object to display the risk guidance object for the mobile object in the omnidirectional image.

The generating of the omnidirectional image may include converting a coordinate system of the plurality of flight images acquired from each of the plurality of cameras equipped in the aerial vehicle into a world coordinate system and matching the plurality of flight images.

The generating of the omnidirectional image may further include generating an omnidirectional capturing image or an omnidirectional modeling image based on the aerial vehicle using the plurality of matched flight images.

In another aspect of the present disclosure, a device for displaying omnidirectional hazard of aerial vehicle includes: a hazard determination unit determining whether a hazard exists within a predetermined range based on a location of the aerial vehicle, and classifying whether the hazard is a mobile object or an immobile object when the hazard exists within a predetermined range based on the location of the aerial vehicle; an omnidirectional image generation unit generating an omnidirectional image based on the aerial vehicle by using a plurality of flight images acquired from each of a plurality of cameras equipped in the aerial vehicle; a guidance object generation unit generating a risk guidance object based on the classified hazard; and a display unit displaying a risk guidance object in the omnidirectional image.

The hazard determination unit may determine whether the hazard is a non-moving immobile object, and the immobile object may include at least one of a building, a region, and an altitude preset in the map data.

The display unit may display a risk guidance object for the immobile object in the omnidirectional image.

The display unit may display a risk guidance object for the immobile object in the omnidirectional image based on a risk level determination result for all directions of the aerial vehicle determined based on at least one of a time to collision (TTC) and a distance required for the aerial vehicle to collide with the immobile object.

The hazard determination unit may determine whether the hazard is a moving mobile object, and the mobile object includes at least one of another aerial vehicle and a bird flock.

The display unit may display a risk guidance object for the mobile object in the omnidirectional image.

The display unit may measure a moving direction of the mobile object and determine whether the moving direction of the mobile object is a direction interfering with a moving route of the aerial vehicle to display the risk guidance object for the mobile object in the omnidirectional image.

The display unit may display the risk guidance object for the mobile object in the omnidirectional image based on a risk level determination result for all directions of the aerial vehicle determined based on a time to collision (TTC) and a distance required for the aerial vehicle to collide with the mobile object.

The omnidirectional image generation unit may convert a coordinate system of the plurality of flight images acquired from each of the plurality of cameras equipped in the aerial vehicle into a world coordinate system and match the plurality of flight images.

The omnidirectional image generation unit may generate an omnidirectional capturing image or an omnidirectional modeling image based on the aerial vehicle using the plurality of matched flight images.

A program stored in a computer-readable recording medium according to an embodiment of the present disclosure for achieving the above object may include a program code for executing the above-described method of displaying an omnidirectional hazard of aerial vehicle.

A program for executing the above-described method of displaying an omnidirectional hazard of aerial vehicle may be recorded in the computer-readable recording medium according to an embodiment of the present disclosure for achieving the above object.

### BRIEF DESCRIPTION OF DRAWINGS

FIG. 1 is a diagram illustrating a conceptual architecture of UAM according to an embodiment of the present disclosure.

FIG. 2 is a diagram for describing an ecosystem of the UAM according to the embodiment of the present disclosure.

FIG. 3 is a diagram for describing locations of tracks and aerodromes flying by a UAM aerial vehicle in a flight corridor of the UAM according to the embodiment of the present disclosure.

FIGS. 4 and 5 are diagrams illustrating the UAM flight corridor according to the embodiment of the present disclosure.

FIG. 6 is a diagram illustrating the flight corridor of UAM for a point to point connection according to an embodiment of the present disclosure.

FIG. 7 is a diagram illustrating a development stage of the UAM.

FIG. 8 is a diagram illustrating a flight mode of aerial vehicle according to an exemplary embodiment of the present disclosure.

FIGS. 9 to 12 are diagrams illustrating a UAM aerial vehicle according to an embodiment of the present disclosure.

FIG. 13 is a block diagram illustrating a device for displaying an omnidirectional hazard according to an embodiment of the present disclosure.

FIG. 14 is a diagram illustrating a hazard according to an embodiment of the present disclosure.

FIG. 15 is a diagram illustrating a method of displaying an omnidirectional hazard of aerial vehicle according to an embodiment of the present disclosure.

FIG. 16 is a flowchart illustrating in detail a method of displaying an omnidirectional hazard of an aerial vehicle by merging map data and sensor-based hazard detection results according to an embodiment of the present disclosure.

FIGS. 17 and 18 are diagrams illustrating a screen displayed on a display unit according to an embodiment of the present disclosure.

FIG. 19 is a block diagram illustrating a UAM aerial vehicle according to an embodiment of the present disclosure.

### DETAILED DESCRIPTION

Hereinafter, detailed embodiments of the present disclosure will be described with reference to the accompanying drawings. The following detailed descriptions are provided to help a comprehensive understanding of methods, devices and/or systems described herein. However, the embodiments are described by way of examples only and the present disclosure is not limited thereto.

In describing the embodiments of the present disclosure, when a detailed description of well-known technology relating to the present disclosure may unnecessarily make unclear the spirit of the present disclosure, a detailed description thereof will be omitted. Further, the following terminologies are defined in consideration of the functions in the present disclosure and may be construed in different ways by the intention of users and operators. Therefore, the definitions thereof should be construed based on the contents throughout the specification. The terms used in the detailed description is merely for describing the embodiments of the present disclosure and should in no way be limited. Unless clearly used otherwise, an expression in the singular form includes the meaning of the plural form. In this description, expressions such as “including” or “comprising” are intended to indicate certain characteristics, numbers, steps, operations, elements, some or combinations thereof, and it should not be interpreted to exclude the existence or possibility of one or more other characteristics, numbers, steps, operations, elements, parts or combinations thereof other than those described.

In addition, terms ‘first’, ‘second’, A, B, (a), (b), and the like, will be used in describing components of embodiments of the present disclosure. These terms are used only in order to distinguish any component from other components, and features, sequences, or the like, of corresponding components are not limited by these terms.

Urban air mobility (UAM) used throughout this specification comprehensively refers to an urban transportation system that transports people and cargo using aircraft rather than ground transportation means. An airframe applied to a UAM operation may include a fixed-wing aircraft and personal air vehicle (PAV) type capable of horizontal take-off and landing, also known as vertical take-off and landing (VTOL) or conventional take-off and landing (CTOL) .

More specifically, the urban air mobility (UAM) enables highly automated, passenger- and cargo-transporting air transport services in and around the urban area.

Urban air traffic is an aggregation of advanced air mobility (AAM) being developed by governments and industries. The AAM enables transportation of people and cargo in regional, local, international and urban environments. Among those, the UAM is being operated to suit movement in the urban area.

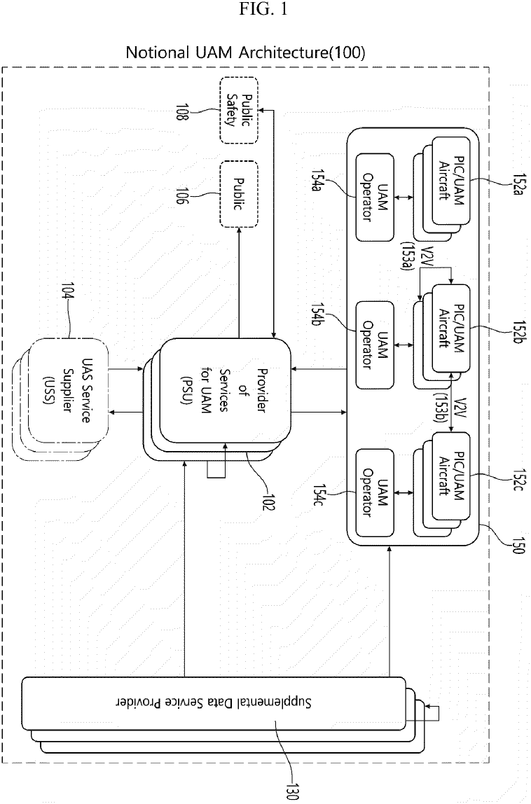

FIG. 1 is a diagram illustrating a conceptual architecture of UAM according to an embodiment of the present disclosure. Hereinafter, referring to FIG. 1, a conceptual architecture 100 of UAM that may be defined in an environment for UAM operation management will be described.

First, terms generally used in this specification will be defined to help understanding of the present disclosure.

A UAM aerodrome refers to a location where a UAM flight operation departs and arrives, a UAM aerial vehicle refers to aircraft capable of performing a UAM operation, a UAM flight corridor is a three-dimensional airspace with performance requirements for operating at a location where tactical air traffic control (ATC) separation services are not provided or are crossed, and an airspace assigned for flight of a UAM aerial vehicle to prevent collisions between a non-UAM aerial vehicle and the UAM aerial vehicle.

The UAM operation refers to transporting passengers and/or cargo from a UAM aerodrome at any one location to a UAM aerodrome at another location.

The UAM operation information includes, but not limited thereto, as information necessary for UAM operation, UAM operation identification information, UAM flight corridor information to be flown, UAM aerodrome information, and UAM operation event information (UAM aerodrome departure time, arrival time, etc.

A UAM operator represents an organization that manages overall UAM operations and performs each UAM operation. The UAM operator corresponds to a server that includes a network unit for managing a flight plan (or intent) of each UAM or a PIC UAM aerial vehicle and transmitting and receiving real-time information to and from each UAM or the PIC UAM aerial vehicle, a storage unit for storing information necessary for flight of each UAM/PIC UAM, a processor for monitoring the flight of each UAM/PIC UAM aerial vehicle and controlling autonomous flight, and a display unit for displaying a flight status of each UAM/PIC UAM aerial vehicle in real time.

An unmanned aircraft system traffic management (UTM) operator is an operator who utilizes UTM-specific services to perform low-altitude unmanned aircraft system (UAS) operation, and corresponds to a server that includes a network unit for transmitting and receiving information to and from each aerial vehicle in real time, a storage unit for storing information necessary for each flight, a processor for monitoring the flight of each aerial vehicle and controlling autonomous flight, and a display unit for displaying a flight status of each aerial vehicle in real time.

In general, since aircraft tends to comply with the regulations of ICAO and the Federal Aviation Administration (FAA), which are international organizations, this specification will also describe the UAM concept from the viewpoint of the FAA establishing regulations for safe operation of UAM.

First, in order to prevent accidents such as a midair collision between the UAM aerial vehicle or between the UAM aerial vehicle and the non-UAM aerial vehicle, it should be possible for the UAM operators to access FAA National Airspace System (NAS) data through FAA-industry data exchange protocols.

This approach enables authenticated data flow between the UAM operators and FAA operating systems. Referring to FIG. 1, UAM operators 154a, 154b, and 154c according to the present disclosure may be configured by a distributed network utilizing an interoperable information system.

In addition, the UAM operators 154a, 154b, and 154c may perform the UAM operation in a scheduled service or on-demand service method through a request of an individual customer or an intermodal operator.

The UAM operators 154a, 154b, and 154c are responsible for all aspects of regulatory compliance and UAM operational execution.

Hereinafter, the use of the term “operator” in this specification refers to an airspace user who has chosen to be operated through cooperative management within the UAM environment. More specifically, the operator may include a UAM operating system including electronic devices that include a processor, memory, database, network interface, communication module, etc., that are connected to a wired/wireless network to perform various controls and management required for the UAM operation.

The UAM operators 154a, 154b, and 154c may be closely connected to PIC/UAM aerial vehicles 152a, 152b, and 152c to exchange various information (flight corridor information, airframe condition information, weather information, aerodrome information, arrival time, departure time, map data, etc.) for flight of the plurality of PIC/UAM aerial vehicles 152a, 152b, and 152c in real time.

A volume of a group of the PIC/UAM aerial vehicles 152a, 152b, and 152c that each of the UAM operators 154a, 154b, and 154c may manage may be set differently according to the capability of the UAM operators 154a, 154b, and 154c. In this case, the capability information of the UAM operators 154a, 154b, and 154c may include the number of UAM aerial vehicles that may be accessed simultaneously, the number of UAM aerial vehicles that may be controlled simultaneously, a network traffic processing speed, processor capability of a server system, and a range of a control area, etc.

Among the plurality of PIC/UAM aerial vehicles 152a, 152b, and 152c, the PIC/UAM aerial vehicle controlled by the same UAM operators 154a, 154b, and 154c may each be grouped into one group and managed. In addition, inter-airframe vehicle to vehicle (V2V) communication 153a may be performed between the PIC/UAM aerial vehicles 152a, 152b, and 152c within the grouped group, and information related to operation may be shared through V2V communication between the PIC/UAM aerial vehicles 152a, 152b, and 152c included in different groups.

To determine desired UAM operational flight plan information such as location of flight (e.g., aerodrome locations), route (e.g., specific UAM corridor(s)), and desired flight time, the UAM operators 154a, 154b, and 154c acquire current status/conditions from at least one of information (environment, situational awareness information, strategic operational demand information, and UAM aerodrome availability) that a PSU 102 and a supplemental data service provider (SDSP) 130 provide.

The UAM operators 154a, 154b, and 154c should provide the flight plan and navigation data to the PSU 102 to be operated within or cross the UAM flight corridor.

In addition, the UAM operators 154a, 154b, and 154c should set planning data in advance for proper preparation when an off-nominal event occurs. The planning data includes understanding of alternative landing sites and the airspace classes bordering the UAM flight corridor(s) for operations.

When all preparations for the UAM operation are completed, the UAM operators 154a, 154b, and 154c provide the information related to the corresponding UAM operation to the PSU 102. In this case, the UAM operators 154a, 154b, and 154c may suspend or cancel the flight of the UAM aerial vehicle until a flight permission message is received from the PSU 102. In another embodiment, even if the UAM operators 154a, 154b, and 154c do not receive the flight permission message from the PSU 102, the UAM operators 154a, 154b, and 154c may start the flight of the UAM aerial vehicle by themselves.

In FIG. 1, the pilot in command (PIC) represents a case where a person responsible for operation and safety of the UAM in flight is on board the UAM aerial vehicle.

The provider of services for UAM (PSU) 102 may serve as an agency that assists the UAM operators 154a, 154b, and 154c to meet UAM operational requirements for safe and efficient use of airspace.

In addition, the PSU 102 may be closely connected with stakeholders 108 and the public 106 for public safety.

To support the capability of the UAM operators 154a, 154b, and 154c to meet the regulations and operating procedures for the UAM operation, the PSU 102 provides a communication bridge between UAMs and a communication bridge between PSUs and other PSUs through the PSU network 206.

The PSU 102 collects the information on the UAM operation planned for the UAM flight corridor through the PSU network 206, and provides the collected information to the UAM operators 154a, 154b, and 154c to confirm the duty performance capability of the UAM operators 154a, 154b, and 154c. Also, the PSU 102 receives/exchanges the information on the UAM aerial vehicles 152a, 152b, and 152c through the UAM operators 154a, 154b, and 154c during the UAM operation.

The PSU 102 provides the confirmed flight plan to other PSUs through the PSU network 206.

In addition, the PSU 102 distributes notification of an operating area in the flight plan (constraints, restrictions), FAA operational data and advisories, and weather and additional data to the UAM operators 154a, 154b, and 154c.

The PSU 102 may acquire UTM flight information through a UAS service supplier (USS) 104 network, and the USS network may acquire the UAM flight information through the PSU network 206.

In addition, the UAM operators 154a, 154b, and 154c may confirm the flight plan shared through the PSUs 102 and other UAM operators, and flight plan information for other flights in the vicinity, thereby controlling safer UAM flights.

The PSU 102 may be connected to other PSUs through the PSU networks 206 to acquire subscriber information, FAA data, SDSP data, and USS data.

The UAM operators 154a, 154b, and 154c and the PSU 102 may use the supplemental data service provider (SDSP) 130 to access support data including terrain, obstacles, aerodrome availability, weather information, and map data for a three-dimensional space. The UAM operators 154a, 154b, and 154c may access the SDSP 130 directly or through PSU network 206.

The USS 104 serves to support the UAS operation under the UAS traffic control (UTM) system.

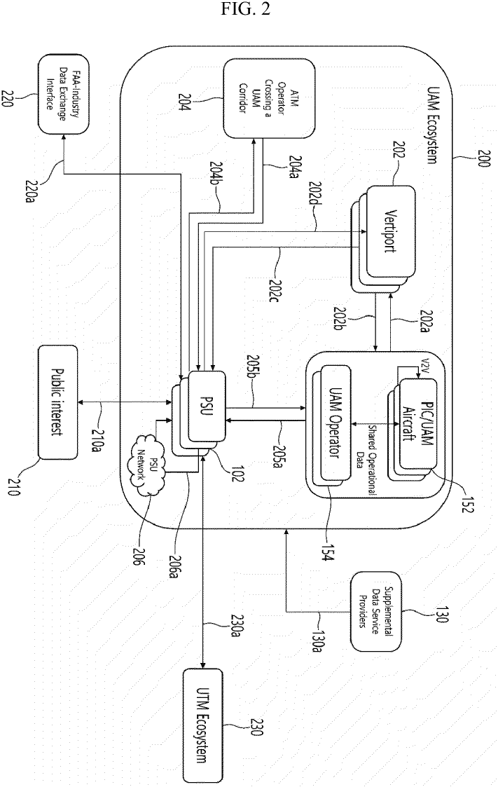

FIG. 2 is a diagram for describing an ecosystem of the UAM according to the embodiment of the present disclosure.

Referring to FIG. 2, the PIC/UAM aerial vehicle 152 and the UAM operator 154 transmit UAM operational intent information and UAM real-time data to a vertiport management system 202 (202a), and the vertiport management system 202 transmits vertiport capacity information and vertiport status information to the PIC/UAM aerial vehicle 152 and the UAM operator 154 (202b).

In addition, the PIC/UAM aerial vehicle 152 and the UAM operator 154 transmit a UAM operational intent request message, UAM real-time data, and UAM operation departure phase status information to the PSU 102 (205a).

The PSU 102 transmits UAM notifications, UAM corridor information, vertiport status information, vertiport acceptance information, and UAM operation intent response message to the PIC/UAM aerial vehicle 152 and the UAM operator 154 (205b). In this case, the UAM operational intent response message includes a response message informing of approval/deny, etc., for the UAM operational intent request.

The vertiport management system 202 transmits the UAM operation departure phase status information, the vertiport status information, and the vertiport acceptance information to the PSU 102 (202c). The PSU 102 transmits the UAM operational intent information and UAM real-time data to the vertiport management system 202 (202d).

In FIG. 2, when aerial vehicles (that is, non-UAMs) other than the UAM aerial vehicles need to cross the UAM flight corridor, the ATM operator 204 crossing the UAM flight corridor transmits a UAM flight corridor crossing request message to the PSU 102 (204a), and the PSU 102 transmits a response message to the UAM flight corridor crossing request message (204b).

In addition, in FIG. 2, the PSU 102 may perform a procedure for synchronizing UAM data with PSUs connected through the PSU network 206.

In particular, the PSU 102 may exchange information with other PSUs through the PSU network 206 to enable UAM passengers and UAM operators to smoothly provide UAM services (e.g., exchange of flight plan information, notification of UAM flight corridor status, etc.).

In addition, the PSU 102 may prevent risks such as collisions with the UAM aerial vehicle and the unmanned aerial vehicle, and transmit and receive UAM off-nominal operational information and UTM off-nominal operational information to and from the UTM ecosystem 230 for smooth control in real time (230a).

In addition, the PSU 102 shares FAA and UAM flight corridor availability, UAM flight corridor definition information, NAS data, a UAM information request, and response to the UAM information request, UAM flight corridor status information, and UAM off-nominal operational information through the FAA industrial data exchange interface 220 (220a).

In addition, the PSU 102 may transmit and receive the UAM information request and the response to the UAM information request to and from a public interest agency system 210. The public interest agency system 210 may be an organization defined by a management process (e.g., FAA, CBR) to have access to the UAM operation information. This access may support activities that include public right to know, government regulation, government guaranteed safety and security, and public safety. Examples of public interest stakeholders include regional law enforcement agencies and United States federal government agencies.

In addition, the UTM ecosystem 230 may receive supplemental data such as terrain information, weather information, and obstacles from supplemental data service providers (SDSP) 130 (130a), and thus, generate information necessary for safe operation of the UAM aerial vehicle.

In an embodiment of the present disclosure, the PSU 102 may confirm a corresponding UAM flight corridor use status through UAM flight corridor use status (e.g., active, inactive) information. For example, when the UAM flight corridor use status information is set to “active,” the PSU 102 may identify whether the UAM flight is scheduled or whether the UAM aerial vehicle is currently flying in the corresponding flight corridor, and when the UAM flight corridor use status information is set to “inactive”, the PSU 102 may identify that there is no UAM aerial vehicle currently flying in the corresponding flight corridor.

In addition, the PSU 102 may store operation data related to the flight of the UAM aerial vehicle in an internal database in order to identify a cause of an accident of the UAM aerial vehicle in the future.

These key functions allow the PSU 102 to provide the FAA with cooperative management of the UAM operation without being directly involved in UAM flight.

The PSU 102 may perform operations related to flight planning, flight plan sharing, strategic and tactical conflict resolution, an airspace management function, and an off-nominal operation.

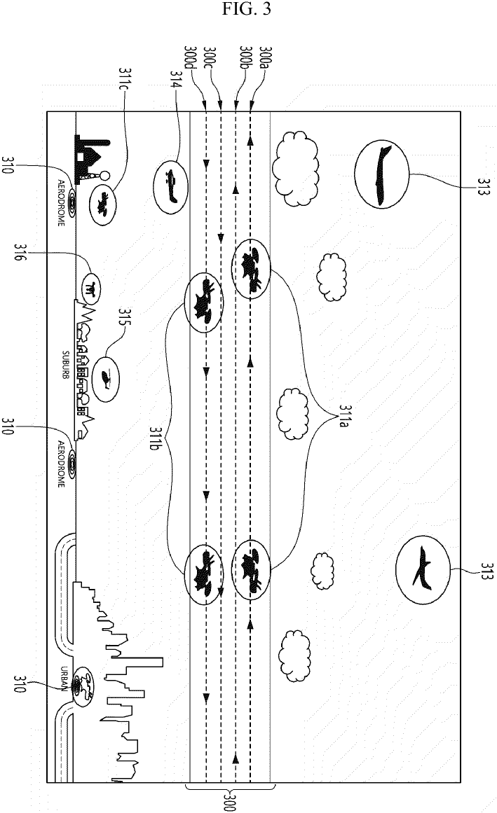

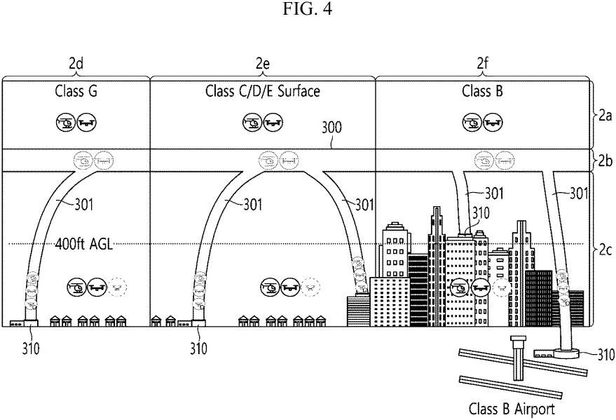

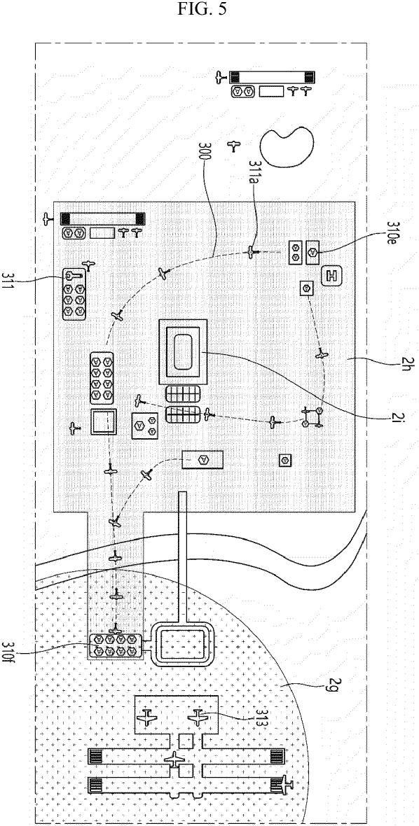

FIG. 3 is a diagram for describing locations of tracks and aerodromes on which UAMs fly within a UAM flight corridor according to an embodiment of the present disclosure, and FIGS. 4 and 5 are diagrams illustrating the UAM flight corridor according to the embodiment of the present disclosure.

It will be described with reference to FIGS. 3 to 5 below.

Referring to FIG. 3, for efficient and safe flight of UAM aerial vehicles 311a and 311b within a UAM flight corridor 300 according to an embodiment of the present disclosure, a plurality of tracks 300a, 300b, 300c, and 300d are provided within the corresponding flight corridor. Each of the tracks 300a, 300b, 300c, and 300d has different altitudes to prevent a collision between the UAM aerial vehicles 311a and 311b, and the number of tracks will be differently set depending on the capacity of the corresponding flight corridor 300.

A UAM aerodrome 310 is an aerodrome that meets capability requirements to support UAM departure and arrival operations. The UAM aerodrome 310 provides current and future resource availability information for UAM operations (e.g., open/closed, pad availability) to support UAM operator planning and PSU strategic conflict resolution. The UAM operator 154 may directly use the UAM aerodrome 310 through the PSU network 206 or through the SDSP 130.

In FIG. 3, the UAM flight corridor 300 should be set to enable the safe and efficient UAM operation without a tactical ATC separation service. Therefore, the UAM flight corridor 300 should be set in relation to the capabilities (e.g., aerial vehicle performance, UAM flight corridor structure, and UAM procedure) of the UAM operator 154.

Additionally, the PSU 102 or the UAM operator 154 may be operated differently within the UAM flight corridor 300 according to operation performance (e.g., aircraft performance envelope, navigation, detection-and-avoidance (DAA)) and participation conditions (e.g., flight intention sharing, conflict resolution within the UAM corridor) of the UAM flight corridor 300.

In addition, the PSU 102 or the UAM operator 154 may set performance and participation requirements of the UAM flight corridor 300 differently between the UAM corridors.

Specifically, the PSU 102 or the UAM operator 154 may variably set the range (flight altitude range) of the UAM flight corridor 300 in consideration of information such as the number of UAM aerial vehicles using the corresponding UAM flight corridor 300, an occupancy request of managements systems (e.g., UTM, ATM) for other aerial vehicles for the corresponding airspace, a prohibited area, and a flight limit altitude.

In addition, the PSU 102 or the UAM operator 154 may share, as the status information for the set UAM flight corridor 300, the UAM flight information (flight time, flight altitude, track ID within the flight corridor, etc.) within the UAM flight corridor with other UAM operators and/or PSUs through the PSU network 206.

Also, the PSU 102 or the UAM operator 154 may set the number of tracks 300a, 300b, 300c, and 300d in the flight corridor according to the range of the UAM flight corridor 300. It is preferable that the corresponding tracks 300a, 300b, 300c, and 300d are defined to have a safe guard set so that the PIC/UAM aerial vehicle 152 flying along the corresponding tracks does not collide with each other. Here, the safe guard may be set according to the height of the UAM aerial vehicle, or even when the UAM aerial vehicle temporarily deviates from a track assigned thereto due to a bird strike or other reasons, the safe guard may be a space set so as not to collide with other UAM aerial vehicles flying on the nearest neighbor track above and below the corresponding track.

In addition, the PSU 102 or the UAM operator 154 may set the tracks 300a, 300b, 300c, and 300d within the flight corridor according to the range of the UAM flight corridor 300, assign a track identifier (Track ID), which is an identifier in the flight corridor 300 for distinguishing the set tracks, and notify the PIC/UAM aerial vehicle 152 scheduled to fly within the corresponding UAM flight corridor 300 of the assigned track ID.

As a result, the PSU 102 or the UAM operator 154 may monitor in real time whether the PIC/UAM aerial vehicle 152 flying in the corresponding flight corridor 300 are flying along each assigned track ID, and when the PIC/UAM aerial vehicle 152 deviate from the assigned track ID, the PSU 102 or the UAM operator 154 may transmit a warning message to the corresponding PIC/UAM aerial vehicle 152, or remotely control the corresponding PIC/UAM aerial vehicle 152.

In the operating environment of the National Airspace System (NAS), the operation type, regulations and procedures of the airspace may be defined to enable the operation of the aerial vehicle, so the airspace according to the operating environment of the UAM, UTM, and air traffic management (ATM) may be defined as follows.

A UAM aerial vehicle 311 may be operated in the flight corridor 300 set above the area in which the UAM aerodromes 310 are located. In this case, the UAM aerial vehicle 311 may be operated in the above-described operable area based on the performance predefined in designing the airframe.

The unmanned aerial system traffic management (UTM) supports the safe operation of the unmanned aerial system (UAS) in an uncontrolled airspace (class G) below 400 ft (120 m) above ground level (AGL) and controlled airspaces (class B, C, D and, E).

On the other hand, the air traffic management (ATM) may be applied in the whole airspace.

In order to operate the UAM aerial vehicle 311, a fixed-wing aircraft 313, and helicopters 315 inside and outside the UAM flight corridor 300 according to the embodiment of the present disclosure, all aircrafts within the UAM flight corridor 300 operate under the regulations, procedures and performance requirements of the UAM. The case of the fixed-wing aircraft 313 and the aircraft controlled by the UTM may cross the UAM flight corridor 300.

In addition, it is preferable that the helicopter 315 and the UAM aerial vehicle 311 are operated in the UAM flight corridor 300, and outside the UAM flight corridor 300, in the outside of the UAM flight corridor 300, the helicopter 315 and the UAM aerial vehicle 311 comply with the operation form, the airspace class, and the flight altitude according to the regulations for the air traffic management (ATM) and the regulations for the UTM.

Of course, the same regulations as described above are applied to visual flight rules (VFR) 314 or unmanned drones 316 in which a pilot recognizes surrounding obstacles with his eyes and flies in a state in which a surrounding visual distance is wide.

The operation of each aerial vehicle described above does not depend on the airspace class, and may be applied based on the inside and outside of the flight corridor 300 of the UAM. Meanwhile, the airspace class may be classified according to purpose such as a controlled airspace, an uncontrolled airspace, a governed airspace, and an attention airspace, or classified according to provision of air traffic service.

The UAM flight corridor 300 allows the UAM aerial vehicle to be operated more safely and effectively without the technical separation control service (management of interference with other aerial vehicles for safety) according to the ATM. In addition, it is possible to help accelerate the operating tempo related to the operating capability, structure, and procedures of the UAM aerial vehicle. In addition, in the present disclosure, by defining the UAM flight corridor 300, it is possible to provide a clearer solution to agencies having an interest in the related field.

The UAM flight corridor 300 may be designed to minimize the impact on the existing ATM and UTM operations, and should be designed to not only consider the regional environment, noise, safety, and security, but also satisfy the needs of customers.

In addition, the effectiveness of the UAM flight corridor 300 should be consistent with the operation design (e.g., changing the flight direction during take-off and landing at a nearby airport or setting direct priority between opposing aircraft) of the ATM. Of course, the UAM flight corridor 300 may be designed to connect the locations of the UAM aerodromes 310 located at two different points for point-to-point connection.

The UAM aerial vehicle 311 may fly along a take-off and landing passage 301 connecting the flight corridor 300 in the aerodrome 310 to enter the UAM flight corridor 300, and the take-off and landing passage 301 may also be designed in a way that minimizes the impact on ATM and UTM operations and should be designed in a way that satisfies the requirements of customers as well as considering the regional environment, noise, safety, security, etc.

The airspace or operation separation within the UAM flight corridor 300 may be clarified through a variety of strategies and technologies. As a preferred embodiment for the airspace or operation separation within the UAM flight corridor 300, a collision may be strategically prevented based on a common flight area, and an area may be technically assigned to the UAM operator 154. In this case, in an embodiment of the present disclosure, PIC and aircraft performance or the like may be considered when separating the airspace or operation within the UAM flight corridor 300.

In addition, since the UAM operator 154 is responsible for safely conducting the UAM operation in association with aircraft, weather, terrain and hazards, it is also possible to separate the UAM flight corridor 300 through the shared flight intention/flight plan, awareness, strategic anti-collision, and establishment of procedural rules.

For example, it can be seen that the UAM flight corridor 300 in FIG. 3 is separated into two airspaces based on the flight direction of the UAM aerial vehicle 311a and 311b. In this case, in FIG. 3, in a relatively high airspace within the UAM flight corridor 300, the UAM aerial vehicle 311a may fly in one direction (from right to left), and in a relatively low airspace, the UAM aerial vehicle 311b may fly in a direction (from left to right) opposite to the one direction.

Meanwhile, the UAS service provider (USS) 104 and the SDSP 130 may provide the UAM operator 154 with weather, terrain, and obstacle information data for the UAM operation.

The UAM operator 154 may acquire the data at the flight planning stage to ensure updated strategic management during the UAM operation and flight, and the UAM operator 154 may continuously monitor the weather during the flight based on the data to make a plan or take technical measures to prevent emergencies such as collisions from occurring within the flight corridor.

Accordingly, the UAM operator 154 is responsible for identifying operation conditions or flight hazards that may affect the operation of the UAM, and this information should be collected during flight as well as pre-flight to ensure safe flight.

The PSU 102 may provide other air traffic information scheduled for cross operation within the UAM flight corridor 300, meteorological information such as meteorological wind speed and direction, information on hazards during low altitude flight, information on special airspace status (airspace prohibited areas, etc.), the availability for the UAM flight corridor 300, etc.

In addition, during the UAM operation, the identification information and location information of the UAM aerial vehicle 311 may be acquired through a connected network between the UAM operator 154 and the PSU 102, but is not preferably provided by automatic dependent surveillance-broadcast (ADS-B) or transponder.

Since the operation of UAM ultimately aims at the unmanned autonomous flight, the identification information and location information of the UAM aerial vehicle 311 are acquired or stored by the UAM operator 154 and the PSU 102, and are preferably used for the operation of the UAM.

Meanwhile, referring to FIG. 4, due to the characteristics of UAM that is operated to suit urban and suburban environments, the aerodrome 310 may be installed in several densely populated regions, and each aerodrome 310 may set a take-off and landing passage 301 connected to the UAM flight corridor 300.

The airspace according to the embodiment of the present disclosure may be divided into an airspace 2a of an area in which the fixed-wing aircraft 313 and rotary-wing aircraft 315, etc., are allowed to fly only according to the instrument flight Rules (IFR) vertically depending on altitude, an airspace 2b in which the UAM flight corridor 300 is formed and airspace 2c in which the take-off and landing passage 301 of the UAM aerial vehicle is formed.

The aerial vehicle illustrated in FIG. 4 may be divided into a UAM aerial vehicle (dotted line) flying in the UAM flight corridor 300, an aerial vehicle (solid line) flying in the airspace according to the operating environment of the air traffic management (ATM), and an aerial vehicle (unmanned aircraft system) (UAS) (dashed line) flying at low altitude operated by the unmanned aircraft system traffic management (UTM) operator.

The airspace according to the embodiment of the present disclosure may be horizontally divided into a plurality of airspaces 2d, 2e, and 2f according to the above-described airspace class.

Also, referring to FIG. 5, the airspace may be divided into an airspace 2g divided into an existing air traffic control (ATC) area and an area 2h where UAM operation or control is performed according to the operation or control area. Of course, the ATC control area 2g and the UAM operation or control area 2h may overlap depending on circumstances.

In the area 2h where the UAM operation or control is performed, a plurality of aerodromes 310e and 310f may exist for the point-to-point flight of the UAM aerial vehicle 311, and a prohibited area 2i may be set in the area 2h where the UAM operation or control is performed.

The UAM flight corridor 300 for the point-to-point flight may be set within the area 2h where the UAM operation or control is performed, except for the area set as the prohibited area 2i.

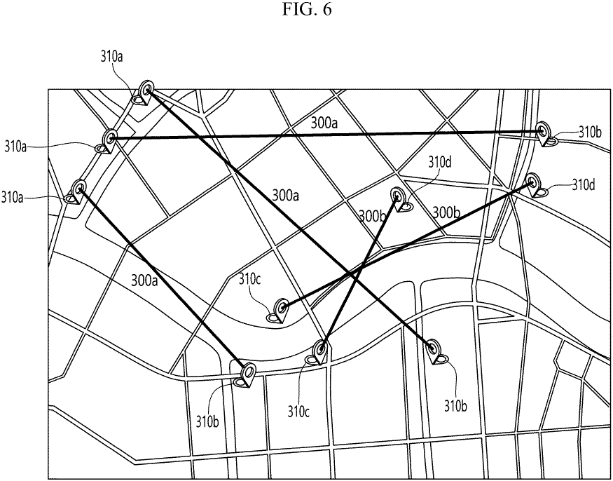

FIG. 6 is a diagram illustrating the aviation corridor of UAM for the point to point connection according to an embodiment of the present disclosure.

This will be described with reference to FIG. 6 below.

The flight corridors 300a and 300b of the UAM aerial vehicle may connect an aerodrome 310a in one region and an aerodrome 310b in another region. The connection between these points may be established within an area excluding special airspace such as the prohibited area 2i within the area 2h where the above-described UAM operation or control is performed, and the altitude at which the UAM flight corridor 300 is set may be set within the airspace 2b in which the UAM flight corridor 300 is set. Here, the aerodrome 310 may refer to, for example, a vertiport in which an aerial vehicle capable of vertical take-off and landing may take-off and land.

Hereinafter, the operation of the above-described UAM will be described.

The UAM may be operated in consideration with the operation within the UAM flight corridor 300, the strategic airspace separation, the real-time information exchange between the UAM operator 154 and the UAM aerial vehicle 311, the performance conditions of the UAM airframe, etc.

The flight of the UAM may be generally divided into a stage of planning a flight in a pre-flight stage, a take-off stage in which the UAM takes off from the aerodrome 310 and enters a vertical take-off and landing passage 51 and climbs, a climb stage in which the UAM climbs from the aerodrome 310 and enters the flight corridor 300, a cruise stage in which the UAM moves along the flight corridor 300, a descend and landing stage in which the UAM enters the take-off and landing passage 51 from the flight corridor 300, and then, descends and enters the aerodrome 310, a disembarking stage after flight, and operation inspection stage.

The operation in each stage may be performed by being divided into the UAM operator 154, the PSU 102 (or SDSP 130), the FAA, the aerodrome operator, and the PIC/UAM passenger. The PIC/UAM passenger may be understood as a concept including both a person who boards the airframe and controls the airframe and passengers who move through the airframe.

In the pre-flight planning stage, the UAM operator 154 may submit the flight plan to the FAA and confirm the passenger list and destination.

The PSU 102 may remove factors that may hinder flight or plan a strategy for the case where an off-nominal situation occurs.

The FAA may review the flight plan submitted by the UAM operator 154 to determine whether to approve the operational plan, and transmit the determination back to the UAM operator 154.

The aerodrome operator may inspect passengers and cargo, perform boarding of passengers, confirm whether the area around the aerodrome 310 is cleared for departure, and notify the UAM operator 154 and/or the PSU 102 of the information on the confirmed result.

The PIC/UAM passenger may finally confirm all hardware and software systems of the UAM aerial vehicle 311 for departure, and notify the UAM operator 154 and/or the PSU 102 through a communication device.

After the FAA notifies the approval of the UAM operation plan, it maintains the authority for the airspace in which the flight route is established in the PIC/UAM flight, but the UAM operators 154 who actually operate the UAM aerial vehicle and/or the PSU 102 directly control/govern the UAM flight operation, so it is preferable that the FAA does not actively participate in the UAM flight.

In addition, in the take-off stage in which the UAM aerial vehicle takes off the aerodrome 310 and climbs, the UAM operator 154 may approve a taxi request or a take-off request of a runway of an airport of the UAM aerial vehicle and transmit a response message thereto to each UAM.

The PSU 102 may sequentially assign priority to each of the plurality of UAM aerial vehicles to prevent the collision between the UAM aerial vehicles and to smoothly control the aerodrome. The PSU 102 controls and monitors only the UAM aerial vehicle to which priority is assigned to move to the runway or take-off.

Before taking off of the UAM aerial vehicle, the aerodrome operator may confirm the existence of obstacles that hinder the takeoff of the UAM around the aerodrome, and may approve the takeoff of the UAM aerial vehicle if there are no obstacles. The PIC/UAM passenger who has received the take-off approval may proceed with the take-off procedure of the UAM aerial vehicle.

In the climb stage in which the UAM aerial vehicle enters the take-off and landing passage 301 from the aerodrome 310, and then climbs and enters the flight corridor 300 and the cruise stage in which the UAM aerial vehicle moves along the flight corridor 300, the UAM operator 154 monitors whether the PIC/UAM is flying according to the flight plan or whether the overall flight operation plan is being followed. In addition, the UAM operator 154 may monitor the status of the UAM aerial vehicle 311 while exchanging data with the PSU 102 and the UAM aerial vehicle 311 in real time and update information and the like if necessary.

The PSU 102 may also monitor the status of the UAM aerial vehicle 311 while exchanging data with the UAM operator 154 and the UAM aerial vehicle 311 in real time, and may deliver the updated operation plan to the UAM operator 154 and the UAM aerial vehicle 311, if necessary.

When the UAM aerial vehicle 311 enters the cruise stage, the aerodrome operator no longer actively participates in the flight of the UAM aerial vehicle 311. In addition, the PIC/UAM aerial vehicle 311 may execute the take-off and cruise procedures, perform collision avoidance or the like through the V2V data exchange, monitor the system of the aerial vehicle in real time, and provide the UAM operator 154 and the PSU 102 with the information such as the aircraft status.

In the descending and landing stage, since the UAM aerial vehicles 152 and 311 have reached near a destination, the cruise mode is terminated and descends and enters the aerodrome 310 after entering the take-off and landing passage 301 from the flight corridor 300. Even during the descend and landing stage, the UAM operator 154 may continuously monitor the flight status/airframe status of the UAM aerial vehicles 152 and 311 and at the same time, monitor whether the flight of the UAM aerial vehicles 152 and 311 complies with a predefined flight operation plan.

In addition, the UAM aerial vehicles 152 and 311 may be assigned a gate number or gate identification information to land on the aerodrome through communication with the aerodrome operator while entering the take-off and landing passage 301, and confirm whether the current airframe status is ready for landing (landing gear operation, flaps, rotor status, output status, etc.).

The PSU 102 may request the approval of the landing permission of the UAM aerial vehicle 311 from the aerodrome operator, and transmit, to the UAM aerial vehicle 311, information including compliance matters for moving from the current flight corridor or location of the UAM aerial vehicle 311 to the UAM aerodrome 310 permitted to land.

In addition, the UAM aerial vehicle 311 may confirm whether the aerodrome 310 is in a clear status (status in which all elements that may be obstacles to the landing of the UAM aerial vehicle 311 are removed) through communication with the UAM aerodrome 310, the PSU 102, and the UAM operator 154, and after the landing of the UAM aerial vehicle 311 is completed, the UAM aerial vehicle 311, the PSU 102, and the UAM operator 154 may all identify the end of the flight operation of the corresponding UAM aerial vehicle.

When receiving the landing request from the UAM aerial vehicle 311, the aerodrome operator confirms a gate cleared out of the aerodrome. In addition, when the aerodrome operator secures whether the landing is possible for the confirmed gate, the aerodrome operator transmits landing permission message including the gate ID or gate number to the UAM aerial vehicle 311, and assigns a gate corresponding to a landing zone included in the landing permission message to the UAM aerial vehicle 311.

Also, when receiving the landing permission message from the aerodrome operator, the UAM aerial vehicle 311 lands at a gate assigned thereto according to a predetermined landing procedure.

The PIC/UAM passengers may perform the take-off and landing procedure of the UAM aerial vehicle 311, and may perform procedures of preventing collisions with other UAM aerial vehicles while maintaining V2V communication and moving to a runway after landing.

The stage of planning the flight of the UAM aerial vehicle 311 starts with receiving the flight requirements of the UAM aerial vehicle 311 for the UAM operator 154 to fly point to point between the first aerodrome and the second aerodrome. In this case, the UAM operator 154 may receive data (e.g., weather, situation awareness, demand, UAM aerodrome availability, and other data) for the flight of the UAM aerial vehicle 311 from the PSU 102 or SDSP 130.

In all the stages related to the UAM operation, the UAM operator 154 and the PSU 102 not only need to confirm the identification and location information of the UAM aerial vehicle in real time, but also the PIC/UAM and UAM operator 154 needs to monitor the performance/condition of the aerial vehicle in real time to identify whether the flight status of the UAM aerial vehicle 311 is off-nominal.

Meanwhile, the UAM aerial vehicle 311 may have an off-nominal status for various reasons such as weather conditions and airframe failure. The off-nominal status may refer to an operating situation in which the UAM aerial vehicle 311 does not follow a flight plan planned before flight due to various external or internal factors.

Two cases may be assumed as the case in which the off-nominal flight condition occurs in the UAM aerial vehicle 311. The first case is a case where the PIC/UAM aerial vehicle 152 intentionally does not comply with UAM regulations due to any other reason, and the second case is the unintentional non-compliance with the UAM operating procedures due to contingencies.

In the first case, it may be assumed that the case where the UAM aerial vehicle 311 intentionally (or systematically) does not comply with the planned UAM operating regulations is the case where the UAM aerial vehicle 311 does not comply with the planned flight operation due to airframe performance problems, strong winds, navigation failure, etc.

However, in the first case, the PIC/UAM aerial vehicle 152 may be in a state in which it may safely arrive at the planned aerodrome 310 within the flight corridor 300.

When the PSU 102 identifies that the off-nominal operation according to the first case has occurred in the PIC/UAM aerial vehicle 152, the PSU 102 distributes, to each stakeholder (UAM operator 154, USS 104, vertiport operator 202, UTM ecosystem 230, ATM operators 204, etc.) through a wired/wireless network, PIC/UAM aerial vehicle off-nominal event occurrence information (UAM aerial vehicle identifier where an off-nominal event occurred, UAM aerial vehicle locations (flight corridor identifier, track identifier), information (event type) notifying a type of off-nominal situations, etc.) notifying that an off-nominal operation status has occurred in the PIC/UAM aerial vehicle 152.

In addition, the UAM operator 154 and the PSU 102 receiving the PIC/UAM aerial vehicle off-nominal event occurrence information may generate a new UAM operation plan that may satisfy UAM community based rules (CBR) and performance requirements for operation within the flight corridor 300, and distribute the generated new UAM operation plan to stakeholders again.

In the second case, the case where the UAM aerial vehicle 152 unintentionally does not comply with the UAM operation due to an accidental situation may be a state in which the forced landing (crash landing) of the UAM aerial vehicle 152 is required, and may be a severe situation where the planned flight operation may not be performed.

That is, the second case is the case where, since it is difficult for the PIC/UAM aerial vehicle 152 to safely fly to the planned aerodrome 310 within the flight corridor 300 assigned thereto, the PIC/UAM aerial vehicle 152 may not fly within the flight corridor 300 assigned thereto.

When the off-nominal operation according to the second case has occurred, similar to the first case, the PSU 102 distributes, to each stakeholder (UAM operator 154, USS 104, vertiport operator 202, UTM ecosystem 230, ATM operators 204, etc.) through the wired/wireless network, the PIC/UAM aerial vehicle off-nominal event occurrence information (UAM aerial vehicle identifier where an off-nominal event occurred, UAM aerial vehicle locations (flight corridor identifier, track identifier), information (event type) notifying a type of off-nominal situations, etc.) notifying that an off-nominal operation status has occurred in the PIC/UAM aerial vehicle 152.

In addition, the PIC/UAM aerial vehicle 152 is reassigned a new flight corridor 300 for flight to a previously secured landing spot and a track identifier within the flight corridor 300 in preparation for an emergency situation in the UAM aerial vehicle, and at the same time, may fly in a flight mode to avoid collision damage with other aerial vehicles through communication means (ADS-B, etc.).

Hereinafter, an evaluation indicator for the operation of the UAM aerial vehicle according to an embodiment of the present disclosure will be described.

As shown in <Table 1> below, UAM operational evaluation indicators may include major indicators such as operation tempo, UAM structure (airspace and procedures), UAM regulatory changes, UAM community regulations (CBR), aircraft automation level, etc.

TABLE 1

| | |
|---|---|
| Indicator Item | Description |
| Operation Tempo | It indicates density of UAM operation, frequency of UAM operation, and complexity of UAM operation. |
| UAM Operation Structure (Airspace and Procedure) | It indicates complex level of infrastructure and services supporting UAM operating environment. |
| UAM Operation Regulation | It indicates level of evolution of current regulations required for UAM operation structure and performance. |
| UAM Community Laws and Regulations | It indicates rules supplementing UAM operation regulations for UAM operation and expansion of PSU. |
| Aircraft Automation Level | It may be divided into HWTL (Human-Within-The-Loop), HOTL(Human-On-The-Loop), HOVTL (Human-Over-The-Loop) . 1) HWTL: Stage where person directly controls UAM system 2) HOTL: Stage of system that is controlled under human supervision, i.e., stage in which human actively monitors 3) HOVTL: Stage in which human |
| | performs monitoring passively |

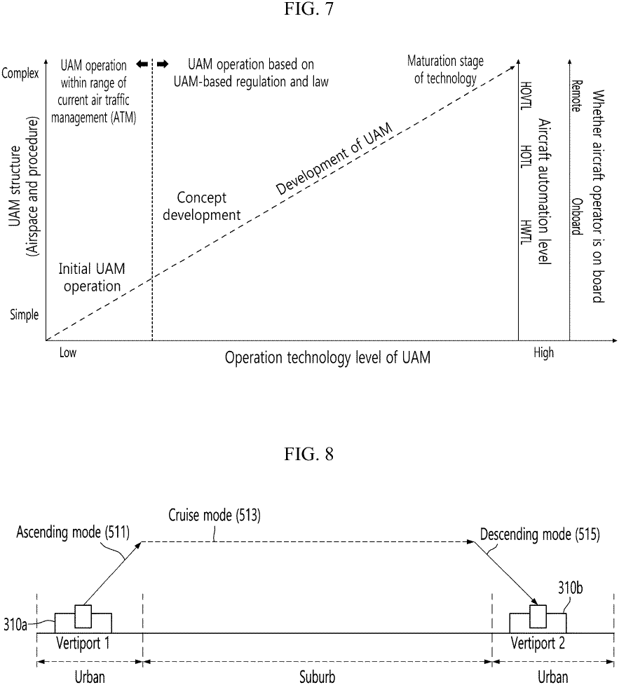

FIG. 7 is a diagram illustrating a development stage of an operating technology level of the UAM.

Hereinafter, concepts of an initial UAM operation stage, a transitional UAM operation stage, and a final UAM operation stage will be described with reference to the above-described key indicators and FIG. 7.

First, in the initial UAM operation stage, the structure of the UAM aerial vehicle is likely to use various existing vertical take-off and landing (VTOL) rotary-wing aircraft infrastructures.

The UAM’s regulatory changes may be gradually implemented while complying with aviation regulations and the like under current laws and regulations. However, the UAM community rules (CBR) may not be separately defined.

The aircraft automation level borrows manned rotary-wing technology, which is currently widely used as of the time this specification is written, but an on-board status may be applied to the pilot in command (PIC) stage.

Next, looking at the transitional UAM operation step, in the UAM structure, the UAM airframe may be operated within a specific airspace based on the performance and requirements of the UAM aerial vehicle.

As for UAM regulations, the ATM regulations may be changed and applied, new regulations for UAM that can be operated may be defined, and the UAM community regulations may also be defined.

In the transitional UAM operation stage, the automation level of the UAM aerial vehicle may be capable of PIC control with an airframe designed exclusively for the UAM, but the on-board status may still be maintained as the PIC stage.

Finally, looking at the final UAM operation stage, the UAM airframe may be operated in a specific airspace based on the performance and requirements of the UAM aerial vehicle, but several variables may exist.

It is predicted that the UAM regulation changes will require additional regulations to enable various operations within the UAM flight corridor, and as the complexity of the UAM community regulations increases, FAA guidelines are expected to increase.

Due to the development of artificial intelligence (AI) technology and the development of aviation airframe technology, the aircraft automation level will be realized at a higher automation level compared to the UAM aerial vehicle at the existing stage. As a result, it is predicted that it will reach the unmanned horizontal or vertical take-off or landing technology level, and the PIC stage may be a stage where remote control is possible.

FIG. 8 is a diagram for describing a flight mode of the UAM aerial vehicle according to an exemplary embodiment of the present disclosure.

Referring to FIG. 8, in an embodiment of the present disclosure, the flight mode of the UAM aerial vehicle may include a take-off mode (not illustrated), an ascending mode 511, a cruise mode 513, a descending mode 515, and a landing mode (not illustrated).

The take-off mode is a mode in which the UAM aerial vehicle takes off from a vertiport 310a at the starting point, the ascending mode 511 is a mode in which the UAM aerial vehicle performs a stage of ascending the flight altitude step by step to enter the cruise altitude, the cruise mode 513 is a mode in which the UAM aerial vehicle flies along the cruise altitude, the descending mode 515 is a mode in which the UAM aerial vehicle performs a stage of descending the altitude step by step in order to land from the cruise altitude to the vertiport 310b of the destination, and the landing stage is a mode in which the UAM aerial vehicle lands on the vertiport 310b of the destination.

In addition, in the take-off mode, the UAM aerial vehicle may perform a taxiing stage to enter the vertiport 310a of the departure point, and even after the landing stage, the UAM aerial vehicle may perform the taxiing stage to enter the vertiport 310b of the destination.

In another embodiment of the present embodiment, in the case of the vertical take-off and landing (VTOL), a take-off mode and the ascending mode 511 may be performed simultaneously, and a landing mode and descending mode 515 may also be performed simultaneously.

In this embodiment, the UAM aerial vehicle is a type of urban transport air transportation means, and the vertiport 310a of the departure point and the vertiport 310b of the destination may be located in the urban area, and according to the cruise mode 513, the aviation corridor on which the UAM aerial vehicle flies may be located in the suburban area outside the urban area.

According to the above-described embodiment of the present disclosure, the take-off mode, the ascending mode 511, the descending mode 515, and the landing mode of the UAM aerial vehicle are performed in a densely populated urban area so thrust may be generated through a distributed electric propulsion (DEP) method to suppress the generation of soot and noise caused by an internal combustion engine.

On the other hand, in the cruise mode 513 of the UAM aerial vehicle, which is mainly performed in the suburban area, the thrust may be generated by an internal combustion engine (ICE) propulsion method in order to increase an operating range, a payload, a flying time, etc.

Of course, the propulsion method for generating the thrust of the UAM aerial vehicle is not necessarily determined for each flight mode described above, and the thrust of the UAM aerial vehicle may be selected by either the DEP method or the ICE method by additionally considering various factors such as the location, altitude, speed, status, and weight of the UAM aerial vehicle.

The operation of the propulsion system according to the flight area of the UAM aerial vehicle according to the embodiment of the present disclosure illustrated in FIG. 8 is summarized in <Table 2> below.

TABLE 2

| | |
|---|---|
| Flight Area | Description of propulsion system operation - control |
| Urban | - Generate lift and thrust only with battery, not internal combustion engines, in consideration of low noise and eco-friendliness |
| | - Flight by selecting propulsion unit that may generate thrust/lift as much as data trained in advance through machine learning (ML) rather than full propulsion system, and generating lift/thrust with only selected propulsion unit |
| Suburb | -In suburban area, which is less sensitive to noise and eco-friendliness than in urban area, thrust is generated through all propulsion units to enable full power flight for cruise flight, and power is supplied through battery or internal combustion engine |

Meanwhile, in the flight stage including the above-described take-off stage, ascending stage, cruise stage, descending stage, and landing stage, the aerial vehicle may generate an omnidirectional guidance image based on the UAM aerial vehicle using a plurality of cameras applied, and risk guidance objects indicating the detected hazards may be displayed in the omnidirectional guidance image. This will be described in more detail later with reference to the drawings.

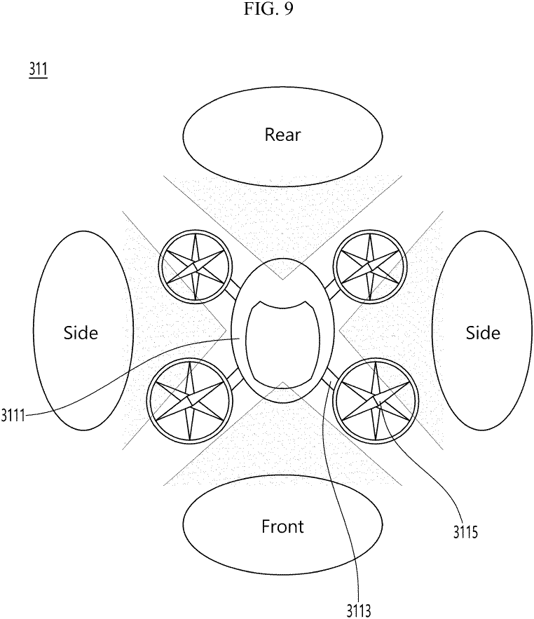

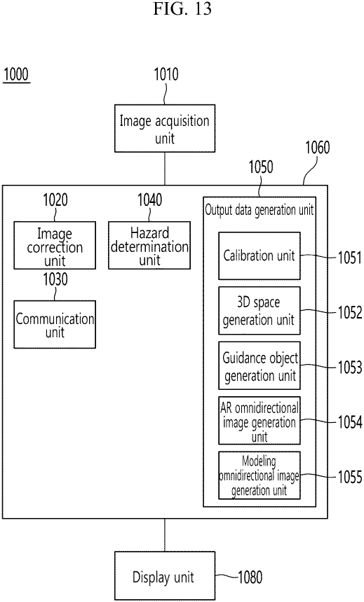

FIGS. 9 to 12 are diagrams illustrating the UAM aerial vehicle according to the embodiment of the present disclosure. More specifically, FIGS. 9 to 11 are diagrams illustrating a multi-camera and a field of view (FOV) applied to a rotary-wing aircraft capable of vertical take-off and landing (VTOL), and FIG. 12 is a diagram illustrating a multi-camera and a field of view applied to a fixed-wing aircraft.

FIGS. 9 to 12 are diagrams exemplarily illustrating a multi-camera applied to the UAM aerial vehicle, and the structure, location, etc., of the multi-camera applied to the UAM aerial vehicle disclosed in this specification are not limited, and as described above, it goes without saying that the multi-cameras can also be applied to an airframe capable of horizontal or vertical take-off and landing.

It will be described with reference to FIGS. 9 to 12 below.

The UAM aerial vehicle 311 of the present embodiment may include a airframe part 3111 that forms an inner space of the UAM aerial vehicle 311, a lift generation unit 3115 that provides lift to the UAM aerial vehicle 311, and a connection part 3113 that connects the airframe part 3111 and the lift generation unit 3115, and the UAM aerial vehicle 311 of this embodiment may be formed as a kind of quadrotor composed of four lift generation units 3115.

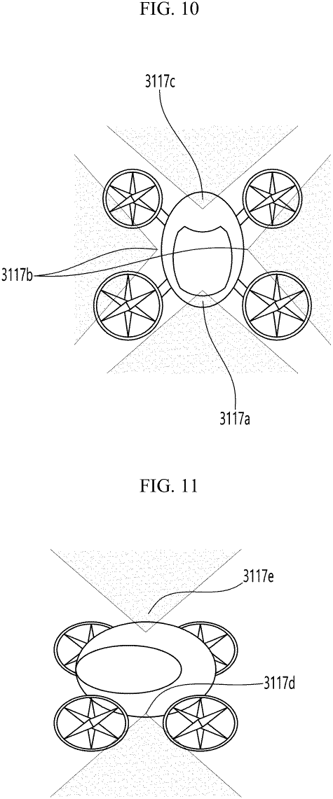

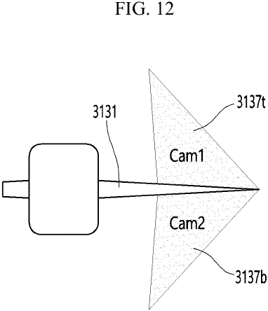

Front, rear, and side directions may be defined based on a flight direction of the UAM aerial vehicle 311 based on FIGS. 9 and 10, and an upper direction and a lower direction of the UAM aerial vehicle 311 may be defined based on FIG. 11.

The multi-camera of this embodiment may be provided at the front, rear, both sides, upper, and lower of the UAM aerial vehicle 311, respectively.

More specifically, in this embodiment, a total of six multi-cameras may be installed: front 3117a, rear 3117c, left and right 3117b, upper portion 3117e, and lower portion 3117d.

In addition, the camera 3117d installed at the bottom may play a role of assisting AR landing when the UAM aerial vehicle 311 lands.

In addition, in the case of the fixed-wing aircraft, as illustrated in FIG. 12, a camera for an upper field of view 3137t and a camera for a lower field of view 3137b may be installed above and below a blade 3131 of the fixed-wing aircraft, respectively.

Here, the plurality of cameras 3117a, 3117b, 3117c, 3117d, and 3117e (hereinafter, referred to as 3117) may be tiltably provided. More specifically, the camera 3117 may be rotatably provided to correspond to an attitude control (roll, pitch, yaw) of the aerial vehicle 311. By rotating the plurality of cameras 3117 in response to the attitude control of the aerial vehicle 311, it is possible to secure the field of view of the image obtained through the plurality of cameras, so images in a certain direction independent of the attitude control of the aerial vehicle 311 may be acquired.

In addition, the plurality of fields of view formed by the plurality of cameras 3117 may be implemented to cover all directions of the real world in which the UAM aerial vehicle 311 flies or may be implemented to cover a part of the real world.

Meanwhile, the above-described UAM aerial vehicle 311 may further include a display unit for displaying a screen, and the display unit of the UAM aerial vehicle 311 may display a risk guidance object in an omnidirectional image based on a hazard classification result. Here, processing of data for display may be performed by an omnidirectional hazard display device 1000 of the aerial vehicle.

Hereinafter, the omnidirectional hazard display device 1000 according to an embodiment of the present disclosure will be described in more detail with reference to FIG. 13.

FIG. 13 is a block diagram illustrating a device for displaying an omnidirectional hazard display device 1000 according to an embodiment of the present disclosure. Referring to FIG. 13, the omnidirectional hazard display device 1000 may include all or part of an image acquisition unit 1010, a data processing unit 1060, and a display unit 1080.

The image acquisition unit 1010 may acquire a plurality of flight images captured through each of the plurality of cameras 3117a, 3117b, 3117c, 3117d, and 3117e (hereinafter referred to as 3117) installed in the aerial vehicle 311. Here, the flight image may be concepts including all images captured by a camera in the overall flight stage of the aerial vehicle 311, including the take-off stage, ascending stage, cruise stage, descending stage, and landing stage of the aerial vehicle 311.

The image correction unit 1020 may perform image stabilization on each of a plurality of flight images acquired by the image acquisition unit 1010. For example, the image correction unit 1020 may use an OIS method of performing image stabilization in hardware using a gyro sensor, an EIS method of correcting image stabilization by cropping a central region of an image using a gyro sensor, etc., to perform the correction of flight images of the aerial vehicle 311 acquired by the image acquisition unit 1010.

The communication unit 1030 is a module for a communication function of the omnidirectional hazard display device 1000, and the communication unit 1030 may receive information transmitted from a control unit or a base station. Here, examples of the information transmitted from the control unit and the base station may include weather information of a flight zone, information of a prohibited area, flight information of other aerial vehicles 311, map data, and the like. Among the information received through the communication unit 1030, information directly or indirectly affecting the flight route of the aerial vehicle 311 may be displayed through the display unit 1080.

Here, the map data may be data constructed as a map of the 3D space in which the aerial vehicle 311 flies. The map data may include static map data that converts static elements of 3D space such as buildings, trees, and terrains into data and dynamic map data that converts dynamic elements of a 3D space into data in real time such as another aerial vehicle 311 and a bird flock.

The hazard determination unit 1040 may determine whether a hazard exists within a predetermined range based on the location of the aerial vehicle 311. In addition, the hazard determination unit 1040 may classify whether the hazard is a mobile object or an immobile object when the hazard exists within a predetermined range based on the location of the aerial vehicle 311. Here, the immobile object may include at least one of a building, a region, and an altitude. The mobile object may include at least one of another aerial vehicle and a bird flock.

In addition, the hazard determination unit 1040 may calculate the location of the mobile object and/or immobile object, and calculate at least one of a distance and a time to collision (TTC) between the aerial vehicle 311 and the mobile object and/or immobile object.

A determination algorithm of the hazard determination unit 1040 will be described in more detail.

### Vision-Based Method

For example, the hazard determination unit 1040 may detect a hazard through image analysis of an omnidirectional flight image, and determine whether the detected hazard is a mobile object or an immobile object. In this case, the hazard determination unit 1040 may use an artificial neural network model, which is a model trained to detect an object from an image, and the artificial neural network model may receive an omnidirectional image in units of frames and generate a bounding box indicating an area of hazards in the image and information on a type of hazard corresponding to the bounding box. For example, according to a non-limiting embodiment of the present disclosure, an object recognition model based on a convolution neural network (CNN) may be used as an artificial neural network model.

In addition, the hazard determination unit 1040 may add a preliminary artificial neural network model to the artificial neural network model so that a deep learning model with a deeper layer may be selected when precise detection is required according to the size and operational speed of the aerial vehicle 311. Here, the preliminary artificial neural network model may be implemented as a Bi-directional feature pyramid network (BiFPN) to effectively detect hazards of various sizes.

In addition, the hazard determination unit 1040 may be implemented to trade off speed-accuracy by clipping the size of the network according to the required performance.

On the other hand, the hazard determination unit 1040 may calculate the location of the hazard in the world coordinate system based on the hazard detection location in the image, and calculate at least one of the distance between the aerial vehicle 311 and the mobile object and/or immobile object and the time to collision (TTC) based on the calculated location.

In addition, the hazard determination unit 1040 may classify whether the hazard is the mobile object or the immobile object based on the information on the types of hazards.

### Sensor Fusion Method

For example, the hazard determination unit 1040 may perform the above-described hazard determination operation based on sensor fusion. In this case, the hazard determination unit 1040 may set a hazard detection area around the aerial vehicle 311 using a plurality of sensors, where the plurality of sensors may include a radio detection and ranging (Radar) sensor, a light detection and ranging (LiDar) sensor, and a camera sensor.

In this case, the hazard determination unit 1040 may set a hazard detection area including a first area formed by the radar sensor, a second area formed by the LiDar sensor, and a third area formed by the camera sensor.

The first area formed by the radar sensor may have a greater coverage than the second area formed by the LiDar sensor and the third area formed by the camera sensor. Also, the second area formed by the LiDar sensor may have a greater coverage than the third area formed by the camera sensor.

The hazard determination unit 1040 may detect hazards in the hazard detection area using at least one of radar sensor data, LiDar sensor data, and camera sensor data acquired according to the hazard detection area, and generate detailed hazard information on the detected hazard.

Here, the detailed hazard information may include location information, kinematic information, geometric information, and semantic information about the hazard. In addition, the hazard detailed information may further include at least one of the type of hazard, flight direction of the hazard, flight speed of hazard, distance between the hazard and the aerial vehicle, time to collision (TTC) between the hazard and the aerial vehicle 311 calculated based on the location information, kinematic information, geometric information, and semantic information of the above-described object. Accordingly, the hazard determination unit 1040 may classify whether the hazard is a mobile object or an immobile object.

### Map Data Method

For example, the hazard determination unit 1040 may perform the above-described hazard determination operation on map data. Specifically, the hazard determination unit 1040 may detect an immobile object using immobile object information corresponding to a static element included in the static map data, and detect a mobile object using mobile object information corresponding to a dynamic element included in the dynamic map data.

Here, each of the immobile object information and mobile object information included in the map data may include location information, and the hazard determination unit 1040 may calculate the location of the mobile object and/or the immobile object based on the location information, and calculate at least one of a distance between the aerial vehicle 311 and the mobile object and/or immobile object and the time to collision (TTC) based on the calculated location.

Meanwhile, the output data generation unit 1050 may generate display data to be displayed through the display unit 1080 and/or voice data to be output through a speaker (not illustrated). In particular, the output data generation unit 1050 may perform an image rendering process for displaying an image on the display unit 1080. This output data generation unit 1050 may include all or part of a calibration unit 1051, a 3D space generation unit 1052, a guidance object generation unit 1053, an AR omnidirectional image generation unit 1054, and a modeling omnidirectional image generation unit 1055.

The calibration unit 1051 may perform calibration for estimating camera parameters corresponding to each of the plurality of cameras 3117 from images captured by the plurality of cameras 3117. Here, the camera parameters, which are parameters configuring a camera matrix, which is information indicating a relationship between a real space and a photograph, may include camera extrinsic parameters and camera intrinsic parameters.

The 3D space generation unit 1052 may generate a virtual 3D space based on the image captured by the plurality of cameras 3117. As an example, the 3D space generation unit 1052 may apply a plurality of camera parameters corresponding to each of the plurality of cameras 3117 to a plurality of images captured by each of the plurality of cameras 3117 to generate virtual 3D spaces corresponding to each of the plurality of captured images.

The guidance object generation unit 1053 may generate various objects for guidance during the flight of the aerial vehicle 311. Specifically, the guidance object generation unit 1053 may generate a risk guidance object indicating the hazard detected by the hazard determination unit 1040. In this case, when the shape, color, size, 2D/3D, etc., of the object indicating hazards (hereinafter, modeling data) are previously generated, the guidance object generation unit 1053 may generate a risk guidance object using the previously generated modeling data. However, when the modeling data indicating hazards is not defined in advance, the guidance object generation unit 1053 may generate the risk guidance object with a simple figure such as a circle or a rectangle.

Also, the guidance object generation unit 1053 may determine a mapping location of the risk guidance object generated in the virtual 3D space.

The omnidirectional image generation unit may include an AR omnidirectional image generation unit 1054 and a modeling omnidirectional image generation unit 1055. Specifically, the omnidirectional image generation unit may convert a coordinate system of a plurality of flight images acquired from each of the plurality of cameras 3117 provided in the aerial vehicle 311 into a world coordinate system using the camera parameters estimated by the calibration unit 1051 to match the plurality of flight images In addition, the AR omnidirectional image generation unit 1054 of the omnidirectional image generation unit may generate an omnidirectional capturing image based on the aerial vehicle 311 using the plurality of matched flight images, and the modeling omnidirectional image generation unit 1055 may generate an omnidirectional modeling image based on the aerial vehicle 311 using the plurality of matched flight images.

In addition, the AR omnidirectional image generation unit 1054 may map the risk guidance object generated by the guidance object generation unit 1053 to the determined mapping location to generate an AR omnidirectional image in which the risk guidance object and the omnidirectional capturing image are combined.

Here, the AR omnidirectional image may include an AR omnidirectional image of a head up display (HUD) method displaying an AR risk guidance object on the omnidirectional image that is transmitted through a windshield of the aerial vehicle 311 and is shown to passengers. For example, the AR omnidirectional image generation unit 1054 may determine the mapping location of the risk guidance object in the virtual 3D space generated by the virtual 3D space generation unit 1052 to determine the projected location of the AR risk guidance object on the windshield, thereby generating the AR omnidirectional image.

In addition, the AR omnidirectional image may include an AR omnidirectional image of a screen display method displaying the AR risk guidance object on the captured aerial vehicle 311 flight image shown to a passenger through a screen. For example, the AR omnidirectional image generation unit 1054 may determine the mapping location of the risk guidance object in a virtual 3D space in the 3D space generation unit 1052, and generate a 2D image corresponding to the virtual 3D space to which the object is mapped, thereby generating the AR omnidirectional image.

The modeling omnidirectional image generation unit 1055 may generate a modeling omnidirectional image by combining the guidance object generated by the guidance object generation unit 1053 with the 2D or 3D modeling image. Here, the 2D or 3D modeling image may be generated by rendering the omnidirectional capturing image or by detecting the 2D or 3D modeling data included in the map data.

Meanwhile, the display unit 65 may display the AR omnidirectional image and/or omnidirectional modeling image generated by the output data generation unit 1050. For example, the display unit 65 may display the AR omnidirectional image on one screen and the modeling omnidirectional image on the other screen.

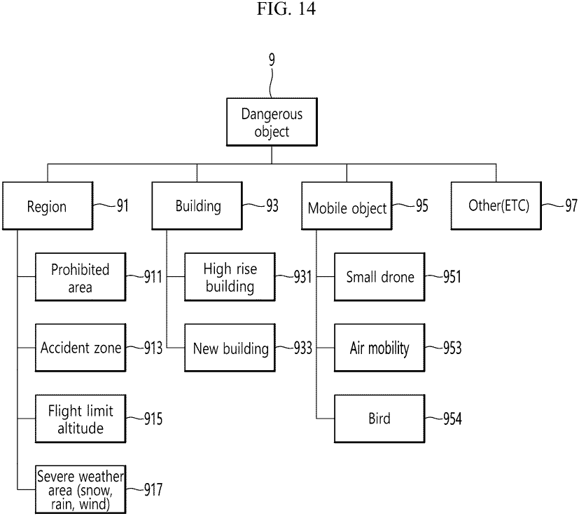

FIG. 14 is a diagram illustrating a hazard according to an embodiment of the present disclosure. The hazard will be described below with reference to FIG. 14.

The classification criteria of the hazard 9 of this embodiment can be divided into four major categories: a region 91, a building 93, a mobile object 95, and others 97.

The region 91 unit may be divided into a prohibited area 911, an accident zone 913, a flight restricted altitude zone 915, and a bad weather zone 917 where normal flight is difficult, and the building 93 may include an existing high-rise building 931 and a new building 933.

The mobile object 95 may be divided into a small drone 951, an air mobility 953, and a bird 954 in detail.

When the above-described hazard 9 is detected, for guidance through the display unit 65, the guidance object generation unit 1053 may generate and store modeling data in which the risk guidance object is modeled in 2D or 3D in advance, and the guidance object generation unit 1053 may generate the risk guidance object by detecting an object matching the type of hazard. Alternatively, when the modeling data indicating hazards is not defined in advance, the guidance object generation unit 1053 may generate the risk guidance object with a simple figure such as a circle or a rectangle.

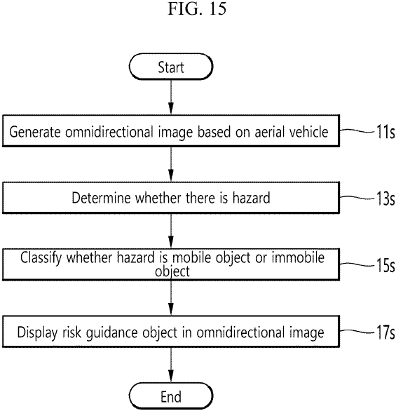

FIG. 15 is a flowchart illustrating a method of displaying an omnidirectional hazard of aerial vehicle according to an embodiment of the present disclosure. Referring to FIG. 15, the output data generation unit 1050 may generate the omnidirectional image based on the aerial vehicle using the plurality of flight images acquired from each of a plurality of cameras provided in the aerial vehicle (11s) .

In addition, the hazard determination unit 1040 determines whether a hazard exists within a predetermined range based on the location of the aerial vehicle (13s), and when the hazard exists within a predetermined range based on the location of the aerial vehicle, it may be classified whether the hazard is a mobile object or immobile object (15s). That is, the hazard determination unit 1040 may determine whether the hazard is a non-moving immobile object and/or a moving mobile object.

Also, the display unit 1080 may display the risk guidance object on the omnidirectional image based on the classified hazard (17s).

For example, when the hazard is detected and classified, the display unit 1080 may display the risk guidance object for the immobile object in the omnidirectional image and/or the risk guidance object for the mobile object in the omnidirectional image.

As another example, the hazard determination unit 1040 may determine the risk level for all directions of the aerial vehicle 311 based on at least one of the time to collision (TTC) and a distance required for the aerial vehicle to collide with the immobile object, and the display unit 1080 may display the risk guidance object for the immobile object and/or the mobile object on the omnidirectional image based on the risk level to be determined.

As an example of implementing such a risk level measurement, when considering a moving distance per second during the flight of the aerial vehicle 311, the display of the risk warning may be displayed by being divided into several risk levels. Therefore, when the hazard determination unit 1040 measures the risk level using a front camera 3117a of the aerial vehicle 311, the time-to-collision (TTC) may be based on the speed of the aerial vehicle 311, and the time-to-collision (TTC) may be calculated as (distance to hazard)/(speed of aerial vehicle).

In addition, when the hazard determination unit 1040 measures the risk level using a side camera 3117b, a rear camera 3117c, an upper camera 3117e, and a lower camera 3117d of the aerial vehicle 311, the TTC may be based on the distance between the aerial vehicle 311 and the hazard 9.

For example, the risk level may be divided into a safety level (displayed in green when displayed on a screen, turn on/off is possible), a level of interest (displayed in blue when displayed on a screen), a caution level (warning using orange color and sound when displayed on a screen, and a speed may be automatically reduced according to pilot setting), and a warning level (warning using red color and sound when displayed on a screen, and speed reduction and airframe stop may be performed automatically according to the pilot setting).

As another example, the hazard determination unit 1040 may measure the moving direction of the mobile object and determine whether the moving direction of the mobile object is a direction that interferes with the moving route of the aerial vehicle 311, and the display unit 1080 may display the risk guidance object for the mobile object in the omnidirectional image based on the determination result. In this case, the hazard determination unit 1040 may determine the risk level by further considering at least one of the estimated time and distance of the collision in the interference route, and as in the above example, the display unit 1080 may display the risk guidance object corresponding to the risk level.

Meanwhile, when the risk level determined by the hazard determination unit 1040 is displayed on the display unit 1080, it is necessary to measure the standards of the mobile object 95 and the immobile objects 91 and 93 differently. This is because the moving direction does not need to be considered in the case of the immobile objects 91 and 93, whereas the moving direction needs to be considered in the case of the mobile object 95.

More specifically, when the hazard 9 is the immobile objects 91 and 93, the hazard level may be estimated based on the speed of the aerial vehicle 311.

When the hazard 9 is a mobile object 95, the risk level is estimated based on the speed of the aerial vehicle 311, but since the speed of the mobile object 95 may not be accurately calculated, it is possible to increase the sensitivity of the risk level. Here, increasing the sensitivity may be, i.e., reducing the range of the criterion value between the risk levels.

Of course, the sensitivity related to the risk level determination can be adjusted by a pilot, and the safety stage may not be used according to the pilot’s determination.

The type of risk of the area 91 among the hazards 9 may be divided into a prohibited area 911, a flight restricted altitude zone 915 (for example, when departing from the set flight altitude), a bad weather zone 917 (for example, the weather of the set flight route becomes bad, etc.), and an accident zone 913 (e.g., vehicle accident, UAM accident, etc.). Data on the region 91 may be acquired based on the map data transmitted from the SDSP 130.

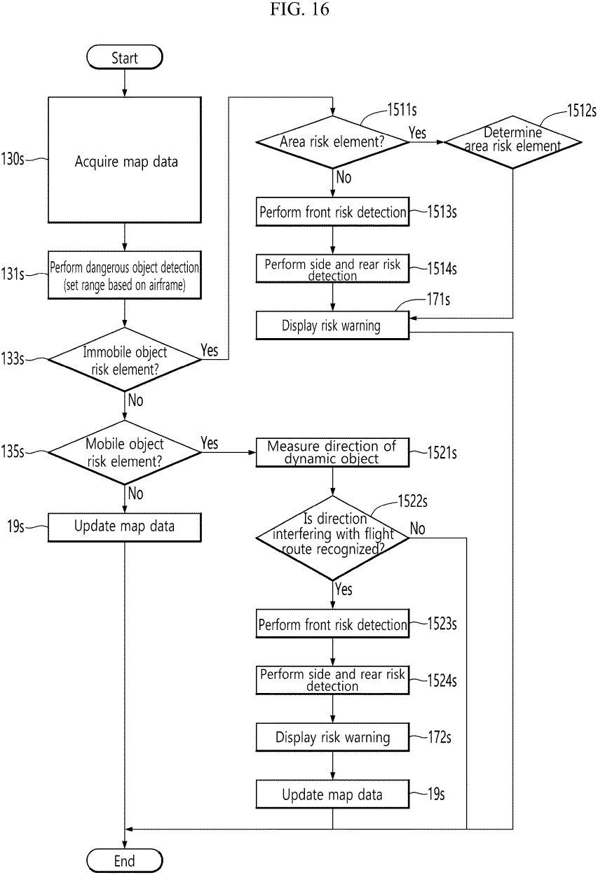

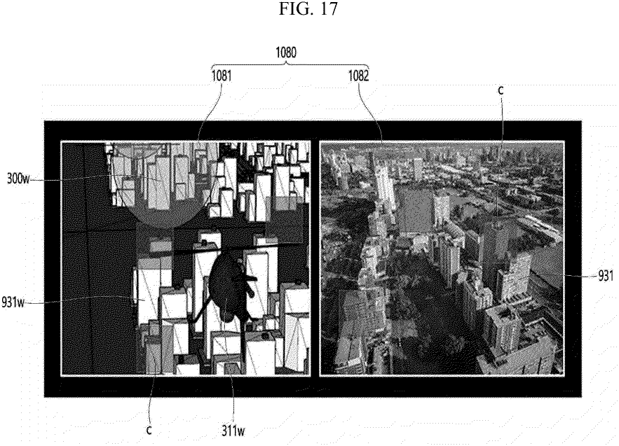

FIG. 16 is a flowchart illustrating in detail a method of displaying an omnidirectional hazard of an aerial vehicle by merging map data and sensor-based hazard detection results according to an embodiment of the present disclosure. Referring to FIG. 16, the method may include acquiring a map data (130s), detecting and classifying a hazard (131s, 133s, and 135s), detecting an immobile object hazard (1511s, 1512s, 1513s, and 1514s), detecting a mobile object hazard (1521s, 1522s, 1523s, and 1524s), and updating map data (19s).

First, the hazard determination unit 1040 may acquire the map data from the SDSP 130 through the communication unit 1030 (130s). Here, the map data may include static map data and dynamic map data.

The hazard determination unit 1040 may set a predetermined range based on the aerial vehicle 311, and then perform the hazard detection within the predetermined range based on at least one of the above-described sensor fusion method or vision-based method.

The hazard determination unit 1040 may compare the hazard detected in step 131s with the map data (preferably, static map data) corresponding to the location of the aerial vehicle 311, so it may be determined whether the detected hazard is the immobile object hazard (133s).

For example, the region 91 may be determined as the immobile object hazard based on the map data, and the building 93 may be determined as the immobile object hazard based on at least one of the map data, the sensor fusion, and the vision-based methods.

Therefore, the hazard determination unit 1040 may determine the detected hazard as the immobile object hazard when only one of the immobile object hazard detected in step 131s and the immobile object hazard detected in the map data is satisfied.

On the other hand, when the detected hazard is the immobile object hazard (133s: Yes), the hazard determination unit 1040 may determine whether the immobile object hazard is a regional hazard 91. For example, the hazard determination unit 1040 may determine (1511s) whether the hazard is a weather hazard such as the bad weather zone 917 using real-time weather data transmitted from the PSU 102 and the UAM operator 154.

In addition, when the immobile object hazard is the regional hazard 91 (1511s: YES), the hazard determination unit 1040 may determine the determined hazard as the regional hazard (1512s), and generate and display the risk guidance object corresponding thereto (171s).

However, when it is determined that the hazard detected in the above step (131s) is not the regional hazard (1511s: NO), the hazard determination unit 1040 may perform detecting the front hazard (1513s) and detecting side and rear hazards (1514s) to display the risk guidance object corresponding to the detected hazard on the display unit 1080 (171s).

For example, when the hazard is not the immobile object hazard as the determination result in the determination step 1511s (1511s: No), the hazard determined in step 133s may correspond to the building 93 or the like. In this case, the hazard determination unit 1040 may display the determined hazard on the display unit 1080, and in the displaying 171s, the hazard risk levels may be classified and displayed according to the risk level calculated as described above.

Meanwhile, when the hazard detected in step 131s is not the immobile object hazard (133s: NO), the hazard determination unit 1040 may determine whether the hazard is the mobile object hazard (135s).

Specifically, the hazard determination unit 1040 may compare the hazard detected in step (131s) with the map data (preferably, dynamic map data) corresponding to the location of the aerial vehicle 311, so it may be determined whether the detected hazard is the mobile object hazard (135s).

For example, the mobile object 95 around the aerial vehicle 311 may be included in the dynamic map data or may be detected through the detection step 131s. In this case, the mobile object 95 included in the dynamic map data may also exist, although not detected through the detection step 131s.

Therefore, the hazard determination unit 1040 may determine the detected hazard as the mobile object hazard when only one of the mobile object hazard detected in step 131s and the mobile object hazard detected in the map data is satisfied.

When the hazard detected in step (131s) is determined as the mobile object hazard (135s: YES), the hazard determination unit 1040 may measure the direction of the mobile object hazard 95 (1521s), and the mobile object hazard 95 may determine whether it moves in the direction of interference on the flight route of the aerial vehicle 311 (1522s) .

Since the mobile object hazard 95 has a vector value unlike the immobile object, even if the mobile object hazard 95 is detected within a predetermined range based on the aerial vehicle 311, when there is no interference on the flight route based on the time-to-collision (TTC), the moving direction, etc., since there is no need to be detected as a hazard, the mobile object hazard 95 does not move in the direction of interference on the flight route of the aerial vehicle 311 (1522s: NO), so there is no need to perform the risk warning display (172s).

However, when the moving direction of the mobileobject hazard 95 is determined to be in the direction interfering with the flight route of the aerial vehicle 311 (1522s: YES), the hazard determination unit 1040 may detect the front hazard of the aerial vehicle 311 (1523s) and the side and rear hazards (1524s) to display the hazard level on the display unit 1080 (172s).

For example, in the detecting of the hazard in front of the aerial vehicle 311 (1523s), the hazard may be detected based on the time-to-collision (TTC) to display the risk stage (172s), and in the detecting of the side and rear hazards (1524s), the hazard may be detected based on the distance between the UAM aerial vehicle and the hazard to display the risk stage (172s).

Meanwhile, when the hazard determination unit 1040 determines that the detected hazard is not the mobile object hazard (135s: NO), the detected hazard may be defined as a new hazard that is not on the map data. Examples of these new hazards include a new building 933 under construction, or the like.

In addition, when the hazard determination unit 1040 detects the mobile object that is not included in the map data, the detected hazard may be defined as a new hazard that is not on the map data. Examples of these new hazards include aerial vehicle such as drones that fly without a flight plan established.

Therefore, in the above case, the hazard determination unit 1040 may update the stored map data (on-device update) or request the SDSP 130 to update the map data (server update) through the communication unit 1030 to map data update 19s such as receiving new map data.

Therefore, when a new hazard requiring the update is detected, the map data is updated, and the map data may be updated on an on-device basis or from a server point of view.

Meanwhile, in the 1513s, 1514s, 1523s, and 1524s, the hazard detection for the front, side, and rear directions has been described as an example, but these steps may further include performing the hazard detection for the upper and lower. Alternatively, it may be implemented by performing the risk detection on at least one of the front, side, rear, upper, and lower directions.

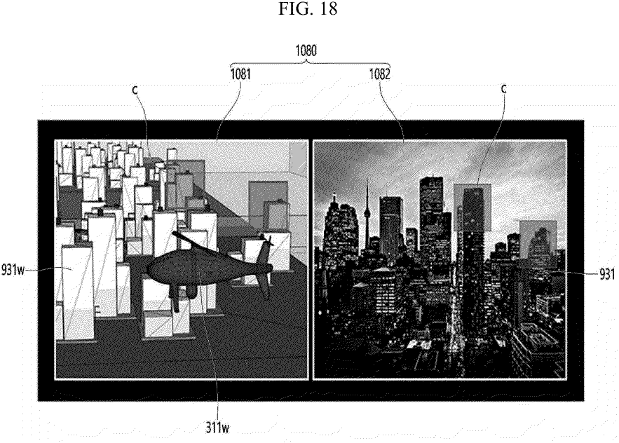

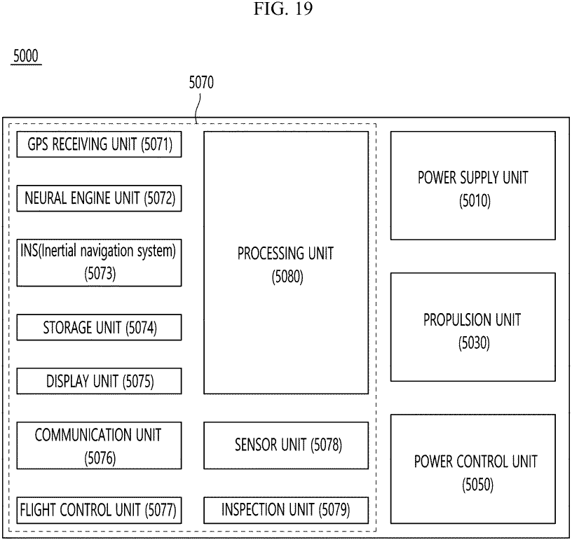

FIGS. 17 and 18 are diagrams illustrating a screen displayed on a display unit according to an embodiment of the present disclosure. FIG. 17 illustrates an example of displaying the omnidirectional direction from the rear viewpoint of the aerial vehicle, and FIG. 18 illustrates an example of displaying the omnidirectional orientation from the left viewpoint of the aerial vehicle.

Referring to FIGS. 17 and 18, the display unit 1080 may be implemented as a display unit 1090 provided in an internal cockpit of the aerial vehicle 311 and may be divided into a plurality of units.

For example, among a plurality of divided displays, one display unit 1081 may display the modeling omnidirectional image, and another display unit 1082 may display the AR omnidirectional image.

Here, the first display unit 1081 may display an omnidirectional modeling image in which hazard guidance objects 300w and c and an aerial vehicle object 311w with a 2D or 3D modeling image 931w are combined.

The second display unit 1082 may display an AR omnidirectional image of a head up display (HUD) method displaying an AR risk guidance object c on an omnidirectional image 931 that is transmitted through a windshield of the aerial vehicle 311 and is shown to passengers.

Alternatively, the second display 1082 may combine the real-time omnidirectional image 931 captured through the plurality of cameras 3117 and the AR risk guidance object c and display an AR omnidirectional image of a screen display method displayed through a screen.

Meanwhile, although not illustrated in FIGS. 17 and 18, the display unit 1080 may divide the risk level into a plurality of stages and display the risk guidance object differently according to the risk level.

For example, the front (flight direction) of the UAM aerial vehicle 311 may calculate a risk level based on an initial velocity distance. The safety stage may be displayed in green when displayed on the display unit 1080, and the expected collision time may be divided into 10 seconds or more. The stage in interest may be displayed in blue when displayed on the display unit 1080, and the expected collision time may be divided within 6 to 10 seconds. The caution stage may be displayed in orange when displayed on the display unit 1080, and the expected collision time may be divided within 3 to 6 seconds. The risk stage may be displayed in red when displayed on the display unit 1080, and the expected collision time may be divided within 3 seconds.

The side and rear directions of the UAM aerial vehicle 311 may set stage-by-stage the case where the distance between the UAM aerial vehicle 311 and the immobile objects 91 and 93 is close based on the distance between the UAM aerial vehicle 311 and the hazard to display the risk level on the display unit 1080.

For example, the safety stage may be displayed in green when displayed on the display unit 1080, and may be divided into 50 m or more. The stage in interest may be displayed in blue when displayed on the display unit 1080, and may be divided within 20 to 50 m. The caution stage may be displayed in orange when displayed on the display unit 1080 and may be classified within 10 to 20 m, and the risk stage may be displayed in red when displayed on the display unit 1080 and may be classified within 10 m.

FIG. 19 is a block diagram illustrating the UAM aerial vehicle according to the embodiment of the present disclosure. Referring to FIG. 19, a UAM aerial vehicle 5000 may include a power supply unit 5010, a propulsion unit 5030, a power control unit 5050, and a flight control system 5070.

The UAM aerial vehicle 5000 of this embodiment may include a propulsion unit 5030 including a plurality of propulsion units, and a fan module including an electric fan motor and a propeller may be applied as an embodiment of the plurality of propulsion units.

The fan module may receive power through the power supply unit 5010, and control of each of the plurality of fan modules may be performed through the power control unit 5050.

Also, the power control unit 5050 may selectively provide any one of power generated through an internal combustion engine and power generated through electric energy to the plurality of fan modules. More specifically, the power control unit 5050 may include a fuel storage unit, an internal combustion engine, a generator, and a battery unit. The fuel storage unit may store fuel required for the operation of the aerial vehicle.

The fuel required for the operation of an aerial vehicle may include taxi fuel required for taxiing on the ground, trip fuel required for one-time landing approach and a missed approach by flying from a departure point to a destination, destination ALT fuel required to fly from the destination to the landing point in case of a nearby emergency, holding fuel required to stay in flight for a certain period of time with the expected weight of the aerial vehicle at the landing point of the destination, additional fuel in case more fuel is required due to a failure of engine, and pressurizer, etc., contingency fuel additionally loading a certain percentage of trip fuel to prepare for an emergency, etc.

The above-described type of fuel is one type for calculating fuel required for the operation of the aerial vehicle, and is not limited to the above-described type, and as will be described later, the amount of fuel stored in the fuel storage unit may be determined by considering the overall energy required for the operation of the aerial vehicle to reach the destination from the departure point together with the battery unit.

The internal combustion engine may generate power to drive a power generation unit by burning fuel stored in the fuel storage unit, and the power generation unit may generate electricity using power generated by the internal combustion engine and provide the power to the propulsion unit 5030.

The battery unit may be charged by receiving power from the power generation unit or by receiving power from the outside.

More specifically, fuel may be stored in the fuel storage unit and power may be supplied to the battery unit to be charged in consideration of total thrust energy required for the aerial vehicle to perform a mission.

However, when it is necessary to charge the battery unit according to the change in flight route due to the off-nominal situation, the battery unit may be charged through the power generation unit as described above.

The power control unit 5050 may include a power supply path control unit, a power management control unit, and a motor control unit, and may be controlled through the flight control system 5007.

Here, the flight control system 5070 may receive a pilot’s control, a pre-programmed autopilot program, etc., through the control signal of the flight control surface, and control the attitude, route setting, output, etc., of the aerial vehicle.

In addition, the flight control system 5070 may process control and operation of various blocks constituting the UAM aerial vehicle.

The flight control system 5070 may include all or part of a processing unit 5080, a GPS receiving unit 5071, a neural engine 5072, an inertial navigation system 5073, a storage unit 5074, a display unit 5075, a communication unit 5076, a flight control unit 5077, a sensor unit 5078, and an inspection unit 5079.

The processing unit 5080 may process various information and data for the operation of the flight control system 5070 and control the overall operation of the flight control system 5070. In particular, the processing unit 5080 may perform the function of the device 1000 for displaying an omnidirectional hazard of aerial vehicle described above, and a detailed description thereof will be omitted.

The aerial vehicle may receive signals from GPS satellites through the GPS receiving unit 5071 to measure the location of the aerial vehicle.

The UAM aerial vehicle 5000 of this embodiment may receive information transmitted from control and base stations through the communication unit 5076. Examples of information transmitted from control and base stations may include weather information of a flight zone, prohibited area information, flight information of other aerial vehicles, etc., and information directly or indirectly affecting the flight route among the information received through the communication unit 5076 may be output through the display unit 5075.

The UAM aerial vehicle 5000 may perform communication with an external control base or other aerial vehicles through the communication unit 5076. For example, the aerial vehicle may perform wireless communication with other UAM aerial vehicles, communication with the UAM operation unit 154 or the PSU 102, communication with a vertiport management system, and the like through the communication unit 5076.

The storage unit 5074 may store information such as various types of flight information related to the flight of the UAM aerial vehicle, flight plan, flight corridor information assigned from the PSU or UAM operator, track ID information, UAM flight data, and map data. Here, the flight information of the UAM aerial vehicle stored in the storage unit 5074 may exemplarily include location information, altitude information, speed information, flight control surface control signal information, propulsion control signal information, and the like of the aerial vehicle.

In addition, the storage unit 5074 may store a navigation map, traveling information, etc., necessary for the UAM aerial vehicle 5000 to travel from a departure point to a destination.

The neural engine 5072 may determine the failure or possibility of failure of each component of the UAM aerial vehicle 5000 through pre-trained data, and the training data may be accumulated through comparison with preset inspection results.

The inspection unit 5079 may compare an inspection result value obtained by inspecting the system of the UAM aerial vehicle 5000 with a preset result value. The above-described comparison may be performed sequentially while matching the components of the power unit and the control surface with the preset result value, and the process or result thereof may be identified to the pilot through the display unit 5075.

The sensor unit 5078 may include an external sensor module and an internal sensor module, and may measure the environment inside and outside the UAM aerial vehicle 5000. For example, the internal sensor module may measure the pressure, the amount of oxygen, etc., inside the UAM aerial vehicle 5000, and the external sensor module may measure the altitude of the UAM aerial vehicle 5000 and the existence of objects around the aerial vehicle, etc.

The inertial navigation system 5073 may use a gyro to create a reference table that maintains a constant attitude in an inertial space and is configured to include a precise accelerometer installed thereon, and may measure the current location of the aerial vehicle by obtaining the flight distance through the acceleration during the operation of the UAM aerial vehicle 5000.

The flight control unit 5077 may control the attitude and thrust of the UAM aerial vehicle 5000. More specifically, the flight control unit 5077 may receive the propulsion power control signal, the flight control surface control signal, etc., from the control surface, the UAM operator 154, the PSU 104, or the like, and control the flight force/control surface of the aerial vehicle.

In addition, the flight control unit 5077 may control the operation of the power control unit 5050. Specifically, the power control unit 5050 may include a power supply path control unit, a power management control unit, and a motor control unit, and the power supply path control unit may select at least one of the power generation unit and the battery unit to supply power to at least one of the plurality of fan modules.

As an example of supplying power to a plurality of fan modules, the power supply path control unit may select at least one of the power generation unit or the battery unit as a power supply source based on the power required to generate the thrust of the aerial vehicle, and then may be controlled to have the same RPM through RPM monitoring of the fan/propeller of the propulsion unit for generating the thrust.

In this case, the power supply control unit may monitor the status of the selected propulsion unit, determine whether there is an operative propulsion unit when an error occurs in any one of the selected at least one propulsion unit, and supply power by selecting the inoperative propulsion unit as an alternative propulsion unit when there is the inoperative propulsion unit.

In addition, when there is no inoperative propulsion unit, the power supply path control unit 651 may determine whether insufficient propulsion force can be offset by increasing the RPM of the propulsion unit 631 in normal operation, and if the offset is possible, the insufficient thrust can be supplemented by controlling the propulsion unit in the normal operation, and an emergency landing procedure can be performed if offset is not possible.

The power management control unit may calculate thrust, power, energy, etc., required for the aerial vehicle to perform a mission, and determine power required for the power generation unit and the battery unit based on the calculated thrust, power, energy, etc.

The motor control unit may control lift, thrust, etc., provided to the aerial vehicle by controlling the fan module.

Meanwhile, the display unit 5075 may display the screen illustrated in FIGS. 17 and 18 like the display unit 1080 of the device 1000.

Hereinabove, the present disclosure has been described with reference to exemplary embodiments. All exemplary embodiments and conditional illustrations disclosed in the present disclosure have been described to intend to assist in the understanding of the principle and the concept of the present disclosure by those skilled in the art to which the present disclosure pertains. Therefore, it will be understood by those skilled in the art to which the present disclosure pertains that the present disclosure may be implemented in modified forms without departing from the spirit and scope of the present disclosure.

Therefore, exemplary embodiments disclosed herein should be considered in an illustrative aspect rather than a restrictive aspect. The scope of the present disclosure should be defined by the claims rather than the above-mentioned description, and equivalents to the claims should be interpreted to fall within the present disclosure.

Meanwhile, the methods according to various exemplary embodiments of the present disclosure described above may be implemented as programs and be provided to servers or devices. Therefore, the respective apparatuses may access the servers or the devices in which the programs are stored to download the programs.

In addition, the methods according to various exemplary embodiments of the present disclosure described above may be implemented as programs and be provided in a state in which it is stored in various non-transitory computer-readable media. The non-transitory computer-readable medium is not a medium that stores data therein for a while, such as a register, a cache, a memory, or the like, but means a medium that semi-permanently stores data therein and is readable by an apparatus. In detail, the various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

According to various embodiments of the present disclosure, it is possible to secure flight stability of aerial vehicle by intuitively detecting and guiding hazards present in all directions of the aerial vehicle to a pilot who controls the aerial vehicle.

The effects of the present disclosure are not limited to the above-mentioned effects, and other effects that are not mentioned may be obviously understood by those skilled in the art from the following description.

Although the exemplary embodiments of the present disclosure have been illustrated and described hereinabove, the present disclosure is not limited to the specific exemplary embodiments described above, but may be variously modified by those skilled in the art to which the present disclosure pertains without departing from the scope and spirit of the disclosure as claimed in the claims. These modifications should also be understood to fall within the technical spirit and scope of the present disclosure.

What is claimed is:

1. A method of displaying an omnidirectional hazard of aerial vehicle, comprising:
generating an omnidirectional image based on the aerial vehicle by using a plurality of flight images acquired from each of a plurality of cameras equipped in the aerial vehicle;
determining whether a hazard exists within a predetermined range based on a location of the aerial vehicle;
classifying whether the hazard is a mobile object or an immobile object when the hazard exists within the predetermined range based on the location of the aerial vehicle; and
displaying a risk guidance object in the omnidirectional image based on the classified hazard.

2. The method of claim 1, wherein the classifying of the hazard includes determining whether the hazard is an immobile object, and
the immobile object includes at least one of a building, a region, and an altitude.

3. The method of claim 2, wherein the displaying includes displaying a risk guidance object for the immobile object in the omnidirectional image.

4. The method of claim 3, wherein the displaying includes determining a risk level for all directions of the aerial vehicle based on at least one of a time to collision (TTC) and a distance required for the aerial vehicle to collide with the immobile object to display the risk guidance object for the immobile object in the omnidirectional image.

5. The method of claim 1, wherein the classifying of the hazard includes determining whether the hazard is a moving mobile object, and
the mobile object includes at least one of another aerial vehicle and a bird flock.

6. The method of claim 5, wherein the displaying includes displaying a risk guidance object for the mobile object in the omnidirectional image.

7. The method of claim 6, wherein, in the displaying, a moving direction of the mobile object is measured, and it is determined whether the moving direction of the mobile object is a direction interfering with a moving route of the aerial vehicle to display the risk guidance object for the mobile object in the omnidirectional image.

8. The method of claim 6, wherein the displaying includes determining a risk level for all directions of the aerial vehicle based on a time to collision (TTC) and a distance required for the aerial vehicle to collide with the mobile object to display the risk guidance object for the mobile object in the omnidirectional image.

9. The method of claim 1, wherein the generating of the omnidirectional image includes converting a coordinate system of the plurality of flight images acquired from each of the plurality of cameras equipped in the aerial vehicle into a world coordinate system and matching the plurality of flight images.

10. The method of claim 9, wherein the generating of the omnidirectional image further includes generating an omnidirectional capturing image or an omnidirectional modeling image based on the aerial vehicle using the plurality of matched flight images.

11. A device for displaying omnidirectional hazard of aerial vehicle, comprising:
a hazard determination unit determining whether a hazard exists within a predetermined range based on a location of the aerial vehicle, and classifying whether the hazard is a mobile object or an immobile object when the hazard exists within a predetermined range based on the location of the aerial vehicle;
an omnidirectional image generation unit generating an omnidirectional image based on the aerial vehicle by using a plurality of flight images acquired from each of a plurality of cameras equipped in the aerial vehicle;
a guidance object generation unit generating a risk guidance object based on the classified hazard; and
a display unit displaying a risk guidance object in the omnidirectional image.

12. The device of claim 11, wherein the hazard determination unit determines whether the hazard is a non-moving immobile object, and
the immobile object includes at least one of a building, a region, and an altitude preset in the map data.

13. The device of claim 12, wherein the display unit displays a risk guidance object for the immobile object in the omnidirectional image.

14. The device of claim 13, wherein the display unit displays a risk guidance object for the immobile object in the omnidirectional image based on a risk level determination result for all directions of the aerial vehicle determined based on at least one of a time to collision (TTC) and a distance required for the aerial vehicle to collide with the immobile object.

15. The device of claim 11, wherein the hazard determination unit determines whether the hazard is a moving mobile object, and
the mobile object includes at least one of another aerial vehicle and a bird flock.

16. The device of claim 15, wherein the display unit displays a risk guidance object for the mobile object in the omnidirectional image.

17. The device of claim 16, wherein the display unit measures a moving direction of the mobile object, and determines whether the moving direction of the mobile object is a direction interfering with a moving route of the aerial vehicle to display the risk guidance object for the mobile object in the omnidirectional image.

18. The device of claim 16, wherein the display unit displays the risk guidance object for the mobile object in the omnidirectional image based on a risk level determination result for all directions of the aerial vehicle determined based on a time to collision (TTC) and a distance required for the aerial vehicle to collide with the mobile object.

19. The device of claim 11, wherein the omnidirectional image generation unit converts a coordinate system of the plurality of flight images acquired from each of the plurality of cameras equipped in the aerial vehicle into a world coordinate system and matches the plurality of flight images.

20-21. (canceled)

22. A computer-readable recording medium in which a program for executing the method of displaying an omnidirectional hazard of aerial vehicle, wherein the method comprising:
generating an omnidirectional image based on the aerial vehicle by using a plurality of flight images acquired from each of a plurality of cameras equipped in the aerial vehicle;
determining whether a hazard exists within a predetermined range based on a location of the aerial vehicle;
classifying whether the hazard is a mobile object or an immobile object when the hazard exists within the predetermined range based on the location of the aerial vehicle; and
displaying a risk guidance object in the omnidirectional image based on the classified hazard.
